(19) United States
(12) Patent Application Publication
(10) Pub. No.: US 2018/0348553 A1
(43) Pub. Date: Dec. 6, 2018

(54) LIQUID CRYSTAL DISPLAY DEVICE

(71) Applicant: SHARP KABUSHIKI KAISHA, Sakai City, Osaka (JP)

(72) Inventors: TAKAKO KOIDE, Sakai City (JP); KIYOSHI MINOURA, Sakai City (JP); KOZO NAKAMURA, Sakai City (JP); AKIRA SAKAI, Sakai City (JP); MASAHIRO HASEGAWA, Sakai City (JP)

(21) Appl. No.: 15/780,541

(22) PCT Filed: Nov. 30, 2016
(86) PCT No.: PCT/JP2016/085475

§ 371 Date: May 31, 2018

(30) Foreign Application Priority Data
Dec. 2, 2015 (JP) 2015-236036

(51) Int. Cl. G02F 1/1337; G02F 1/1335; G02F 1/139; G02F 1/13363; G02F 1/1343; G02F 1/1333

(52) U.S. Cl. CPC G02F 1/1337; G02F 1/133602; G02F 1/1396; G02F 1/13363; G02F 2001/13706; G02F 1/133528; G02F 1/133345; G02F 2201/121; G02F 2201/123; G02F 1/134309

(57) ABSTRACT

A liquid crystal display device includes a transmissive region and a reflective region, and includes a backlight unit and a liquid crystal display panel including a first substrate, a first alignment film, a liquid crystal layer containing liquid crystal molecules having positive anisotropy of dielectric constant, a second alignment film, and a second substrate in the given order from closest to farthest from the backlight unit, the first substrate including a first electrode disposed in the transmissive region and the reflective region and a second electrode disposed in the transmissive region, the first substrate or the second substrate including a third electrode disposed in the reflective region, the first electrode including one or more first linear electrode portions in the transmissive region, with no voltage applied to the liquid crystal layer, the liquid crystal molecules in the transmissive region forming a given twist angle θ1, the liquid crystal molecules in the reflective region forming a given twist angle θ2, and an alignment azimuth of liquid crystal molecules adjacent to the first alignment film or the second alignment film in the reflective region being parallel to the alignment azimuth of liquid crystal molecules adjacent to the first alignment film in the transmissive region.

### TECHNICAL FIELD

The present invention relates to liquid crystal display devices. More specifically, the present invention relates to a transflective liquid crystal display device.

### BACKGROUND ART

Liquid crystal display devices are roughly classified into reflective ones and transmissive ones, depending on how light is transmitted through the liquid crystal layer. Reflective liquid crystal display devices include a reflector therein and provide display by reflecting incident light from the outside on the reflector and allowing the reflected light to pass through the liquid crystal layer. Transmissive liquid crystal display devices include a backlight unit and provide display by allowing light emitted from the backlight unit to pass through the liquid crystal layer. Since reflective liquid crystal display devices do not require a backlight unit, the reflective liquid crystal display devices can achieve low power consumption, a thin profile, and a light weight. Meanwhile, transmissive liquid crystal display devices, including a light source therein, exhibit favorable visibility even in a dark environment.

For visibility under external light as well as indoor visibility, liquid crystal display devices having advantages of both reflective liquid crystal display devices and transmissive liquid crystal display devices have been suggested. Such liquid crystal display devices include a transflective liquid crystal display device. In particular, horizontal alignment modes such as the in-plane switching (IPS) mode and the fringe field switching (FFS) mode have been studied because they have excellent viewing angle characteristics (for example, Patent Literature 1).

In a horizontal alignment mode, however, a liquid crystal display device with normally black transmissive regions as in Patent Literature 1, for example, has normally white reflective regions and thus unfortunately causes brightness inversion in which brightness is inverted between the transmissive regions and the reflective regions. Non-Patent Literature 2, for example, suggests a method to deal with this problem in which different electrodes are provided in the transmissive regions and the reflective regions and display is provided in bright and dark tones by line inversion driving. Non-Patent Literature 1 and Non-Patent Literature 3, for example, suggest another method in which a retarder (in-cell retarder) is disposed in the reflective regions, and the transmissive regions are set to λ/2 retardation and the reflective regions are set to λ/4 retardation. Non-Patent Literature 4, for example, suggests production of a transflective liquid crystal display device including a liquid crystal layer whose thickness is uniform without use of any in-cell retarder by driving the transmissive regions with fringe electric fields and driving the reflective regions with fringe electric fields or vertical electric fields.

### CITATION LIST

### Patent Literature

### Patent Literature 1: JP 2003-344837 A

### Non-Patent Literature

Non-Patent Literature 1: Hirotaka Imayama, “Novel Pixel Design for a Transflective IPS-LCD with an In-Cell Reterder”, Society for Information Display DIGEST (US), 2007, 57.1
Non-Patent Literature 2: Takehiro Ochiai, “Low Cost Reterder-less IPS-LCD”, Society for Information Display DIGEST (US), 2007, 34.5L
Non-Patent Literature 3: Shoichi Hirota, “Transflective LCD Combining Transmissive IPS and Reflective In-Cell Reterder ECB”, Society for Information Display DIGEST (US), 2007, 57.4L
Non-Patent Literature 4: Jung Hwa Her, “Transflective Fringe-Field Switching Liquid Crystal Display without Any Reterder”, Society for Information Display DIGEST (US), 2010, P-139

### SUMMARY OF INVENTION

### Technical Problem

Non-Patent Literature 1 discloses a configuration in which the IPS mode electrode arrangement is employed in both the transmissive regions and the reflective regions, the liquid crystal retardation value in the transmissive regions is λ/2, and a retarder (in-cell retarder) is disposed in the reflective regions to give λ/4 retardation, so that the reflective regions collectively function as a wide-ranging circular polarizer.

Non-Patent Literature 2 discloses an IPS mode transflective liquid crystal display device which includes different electrodes in the reflective regions and the transmissive regions and applies different levels of voltage to the electrodes so as to provide display by line inversion driving. The liquid crystal display device provides black display by applying a low level of voltage to the transmissive regions and a high level of voltage to the reflective regions, while providing white display by applying a high level of voltage to the transmissive regions and a low level of voltage to the reflective regions.

Non-Patent Literature 3 discloses an LCD which provides black display and white display using its IPS mode horizontal alignment transmissive regions with a liquid crystal retardation value of λ/2. The LCD has a liquid crystal retardation value of λ/4 in the reflective regions. The LCD provides black display by the IPS mode horizontal alignment while providing white display in an electrically controlled birefringence (ECB) mode. The ECB mode is a display mode utilizing birefringence of liquid crystal which changes the retardation value by voltage application to the liquid crystal molecules and controls transmission of light in combination with retarders.

Non-Patent Literature 4 discloses a configuration with which display is provided without any in-cell retarder. In this configuration, the initial alignment azimuth of liquid crystal molecules in the transmissive regions is parallel to the polarization axis of the polarizer of the upper substrate, the initial alignment azimuth of liquid crystal molecules in the reflective regions forms an angle of 45° with the polarization axis of the polarizer of the upper substrate, and a large pre-tilt angle is provided such that the liquid crystal retardation value is set to λ/4.

In the liquid crystal display devices in Non-Patent Literatures 1 and 3, however, the liquid crystal layer has a small thickness in the reflective regions so as to show a retardation of λ/4, and current leakage can occur between the upper and lower substrates. In the horizontal alignment mode such as the IPS mode in Non-Patent Literature 1, the anchoring energy between the alignment film and the liquid crystal molecules is very strong and restricts movement of the liquid crystal molecules, leading to insufficient response performance of the liquid crystal molecules. The configuration in Non-Patent Literature 2 employs line inversion driving which requires different electrodes between the transmissive regions and the reflective regions, and therefore can still be improved in terms of the productivity. The configuration in Non-Patent Literature 4 requires UV application to an active polymer (reactive mesogen) and a pre-tilt angle as large as about 500 in order to achieve λ/4 retardation of the liquid crystal layer, and is thus difficult to practice and produce massively.

The present invention has been made in view of the above current state of the art and aims to provide a transflective liquid crystal display device having good display quality and excellent productivity.

### Solution to Problem

The present inventors have studied a method for providing display while avoiding brightness inversion between the transmissive region and the reflective region in a horizontal alignment mode transflective liquid crystal display device. The study has found that with liquid crystal molecules twist-aligned between the upper and lower substrates in the reflective region with no voltage applied, white display and black display can be provided without any in-cell retarder while brightness inversion between the transmissive region and the reflective region is avoided. The study has also found that the thickness of the liquid crystal layer in the reflective region can be half or more of the thickness of the liquid crystal layer in the transmissive region when the alignment azimuth of liquid crystal molecules near the upper substrate and the alignment azimuth of liquid crystal molecules near the lower substrate form an angle of 30° or greater and 800 or smaller in the reflective region. This configuration can enhance response performance of the liquid crystal molecules in the reflective region and reduce current leakage between the upper and lower substrates. The inventors have thereby found the solution to the above problem, completing the present invention.

One aspect of the present invention may be a liquid crystal display device including a transmissive region and a reflective region, including a backlight unit and a liquid crystal display panel including a first substrate, a first alignment film, a liquid crystal layer containing liquid crystal molecules having positive anisotropy of dielectric constant, a second alignment film, and a second substrate in the given order from closest to farthest from the backlight unit, the first substrate including a first electrode disposed in the transmissive region and the reflective region and a second electrode disposed in the transmissive region, the first substrate or the second substrate including a third electrode disposed in the reflective region, the first electrode including one or more first linear electrode portions in the transmissive region, with no voltage applied to the liquid crystal layer, the liquid crystal molecules in the transmissive region forming a twist angle θ1 of 0° or greater and smaller than 30°, the liquid crystal molecules in the reflective region forming a twist angle θ2 of 30° or greater and 80° or smaller, and an alignment azimuth of liquid crystal molecules adjacent to the first alignment film in the reflective region or an alignment azimuth of liquid crystal molecules adjacent to the second alignment film in the reflective region being parallel to the alignment azimuth of liquid crystal molecules adjacent to the first alignment film in the transmissive region. The expression “with no voltage applied” encompasses the case where the voltage applied to the liquid crystal layer is 0 V and cases where the applied voltage is lower than the threshold voltage of the liquid crystal molecules. The expression “being parallel” as used herein may refer to the case where two azimuths form an angle of 0° or an angle of 0° to 30° from the 0° point in the clockwise or counterclockwise direction.

### Advantageous Effects of Invention

The liquid crystal display device of the present invention is a horizontal alignment mode transflective liquid crystal display device which has excellent viewing angle characteristics, low power consumption, and excellent indoor and outdoor visibility. The liquid crystal display device can provide black display and white display without any in-cell retarder in the reflective region owing to its configuration in which the alignment azimuths of the liquid crystal molecules are twist-aligned between the upper substrate and the lower substrate in the reflective region. Thereby, the liquid crystal display device has high productivity. In addition, the thickness of the liquid crystal layer in the reflective region can be half or more of the thickness of the liquid crystal layer in the transmissive region, so that better response performance of liquid crystal molecules can be achieved in the reflective region and current leakage can be reduced between the upper and lower substrates.

### BRIEF DESCRIPTION OF DRAWINGS

FIG. 1 is a schematic cross-sectional view of an exemplary liquid crystal display device of Embodiment 1 with no voltage applied.

FIG. 2 is a schematic cross-sectional view of the liquid crystal display device shown in FIG. 1 with voltage applied.

FIG. 3 is a schematic plan view of the liquid crystal display device shown in FIG. 1 with no voltage applied.

FIG. 4 is a schematic plan view of the liquid crystal display device shown in FIG. 1 with voltage applied.

FIG. 5 includes schematic plan views showing exemplary shapes of a first electrode.

FIG. 6 is a graph showing the transmittance in the transmissive region versus applied voltage with various widths of the first linear electrode portions and various distances between the first linear electrode portions.

FIG. 7 is a graph showing the gradient of the voltage-transmittance curve at 5 V.

FIG. 8 is a graph showing changes in transmittance (%) versus width (L) of the first linear electrode portions.

FIG. 9 is a schematic cross-sectional view of an exemplary configuration of the first substrate.

FIG. 10 is a schematic cross-sectional view of another exemplary configuration of the first substrate.

FIG. 11 is a perspective view of the liquid crystal display device shown in FIG. 1 with no voltage applied.

FIG. 12 is a perspective view of the liquid crystal display device shown in FIG. 1 with voltage applied.

FIG. 13 is a simulation view showing the relationship between a liquid crystal retardation value and a twist angle in the reflective region.

FIG. 14 is a graph comparing the reflectance values in the reflective region in Configuration 1 and Configuration 2.

FIG. 15 is a graph comparing changes in reflectance depending on the alignment azimuths of the liquid crystal molecules in Configuration 1.

FIG. 16 is a schematic view illustrating twist angles of a liquid crystal molecule in the reflective region.

FIG. 17 is a graph showing the dependence of the applied voltage and the reflectance on the anisotropy (Δε) of dielectric constant.

FIG. 18 is a graph showing the relationship between the anisotropy (Δε) of dielectric constant and the viscosity of liquid crystal molecules.

FIG. 19 is a graph showing the reflectance and expected reflectance for white expected voltage levels of 3 V and 5 V.

FIG. 20 includes schematic plan views of exemplary arrangements of a light-shielding layer between pixels.

FIG. 21 is a graph showing wavelength dependence of the liquid crystal retardation value and the reflectance.

FIG. 22-1 includes schematic views illustrating an exemplary process of producing color filters.

FIG. 22-2 includes schematic views illustrating the exemplary process of producing color filters.

FIG. 23 is a schematic cross-sectional view of an exemplary liquid crystal display device of Embodiment 2 with no voltage applied.

FIG. 24 is a schematic cross-sectional view of the liquid crystal display device shown in FIG. 23 with voltage applied.

FIG. 25 is a schematic plan view of the liquid crystal display device shown in FIG. 23 with no voltage applied.

FIG. 26 is a schematic plan view of the liquid crystal display device shown in FIG. 23 with voltage applied.

FIG. 27 is a perspective view of the liquid crystal display device shown in FIG. 23 with no voltage applied.

FIG. 28 is a perspective view of the liquid crystal display device shown in FIG. 23 with voltage applied.

FIG. 29 is a schematic cross-sectional view of an exemplary liquid crystal display device of Modified Example 1 of Embodiment 2 with no voltage applied.

FIG. 30 is a schematic cross-sectional view of an exemplary liquid crystal display device of Embodiment 3 with no voltage applied.

FIG. 31 is a schematic cross-sectional view of the liquid crystal display device shown in FIG. 30 with voltage applied.

FIG. 32 is a schematic plan view of the liquid crystal display device shown in FIG. 30 with no voltage applied.

FIG. 33 is a schematic plan view of the liquid crystal display device shown in FIG. 30 with voltage applied.

FIG. 34 is a schematic plan view of the liquid crystal display device of each of Embodiments 1 and 2 with the reflective region in the IPS mode.

FIG. 35 is a schematic plan view of the liquid crystal display device of each of Embodiments 1 and 2 with the transmissive region in the IPS mode.

FIG. 36 is a schematic plan view of the liquid crystal display device of each of Embodiments 1 and 2 with the reflective region and the transmissive region in the IPS mode.

FIG. 37 is a schematic plan view of the liquid crystal display device of Embodiment 3 with the transmissive region in the IPS mode.

### DESCRIPTION OF EMBODIMENTS

Embodiments of the present invention are described below. The following embodiments, however, are not intended to limit the present invention. The present invention can appropriately be modified within the scope of the configuration of the present invention.

### Embodiment 1

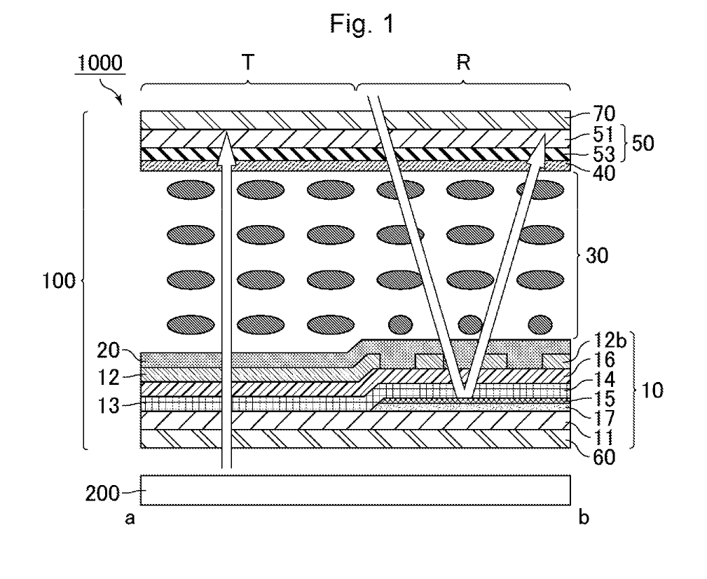

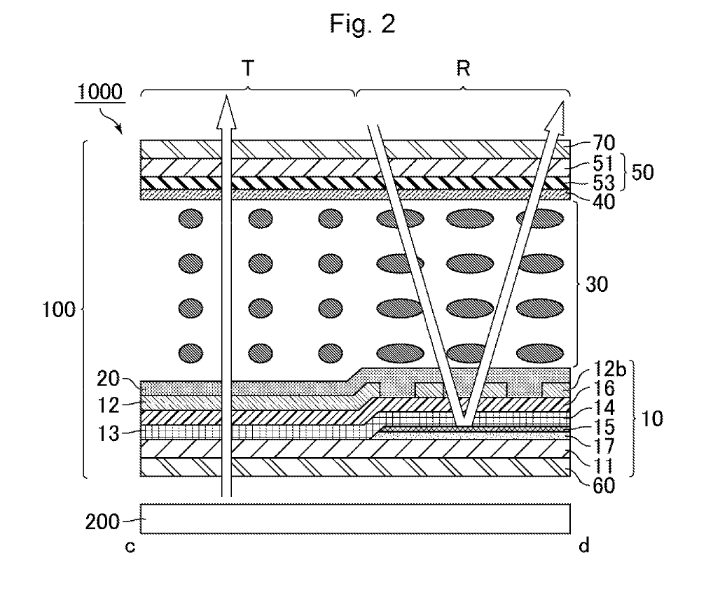

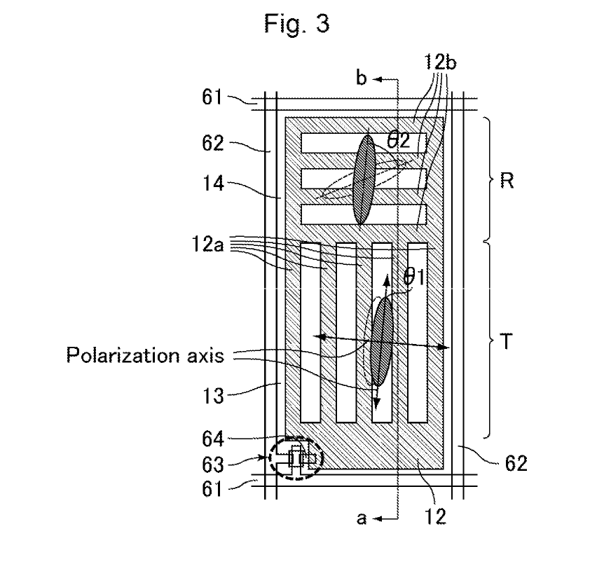

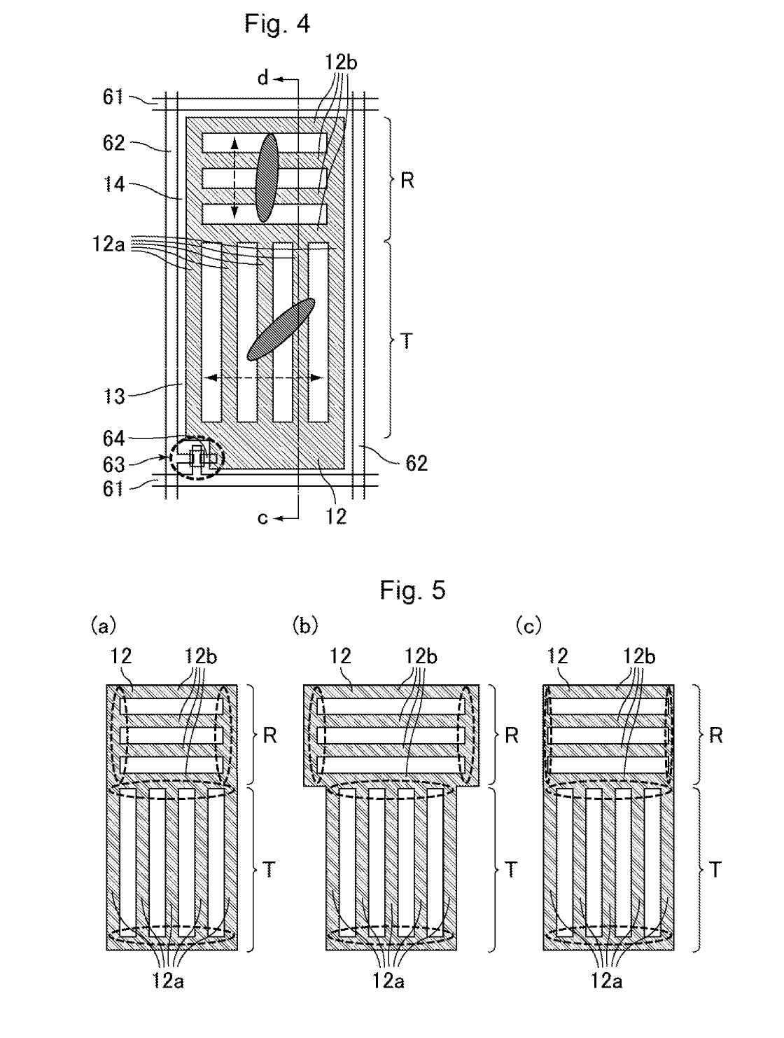

FIG. 1 is a schematic cross-sectional view of an exemplary liquid crystal display device of Embodiment 1 with no voltage applied. FIG. 2 to FIG. 4 are a schematic cross-sectional view of the liquid crystal display device shown in FIG. 1 with voltage applied, a schematic plan view of the liquid crystal display device with no voltage applied, and a schematic plan view of the liquid crystal display device with voltage applied, respectively. FIG. 1 is a cross-sectional view taken along the line a-b in FIG. 3. FIG. 2 is a cross-sectional view taken along the line c-d in FIG. 4. In FIG. 1 and FIG. 2, the white arrows indicate the paths of light. In FIG. 3, liquid crystal molecules adjacent to a first alignment film 20 are indicated by dotted lines, and liquid crystal molecules adjacent to a second alignment film 40 are indicated by solid lines. In FIG. 4, the double-headed dotted arrows each indicate the direction of an electric field. As shown in FIG. 1 and FIG. 2, a liquid crystal display device 1000 of Embodiment 1 includes a backlight unit 200, and a liquid crystal display panel 100 including a first substrate 10, a first alignment film 20, a liquid crystal layer 30 containing liquid crystal molecules having positive anisotropy of dielectric constant, a second alignment film 40, and a second substrate 50 in the given order from closest to farthest from the backlight unit 200. The liquid crystal display panel 100 is a horizontal alignment mode transflective liquid crystal display panel and thus has low power consumption and excellent indoor and outdoor visibility.

The liquid crystal display panel 100 includes a transmissive region T and a reflective region R. The transmissive region T mainly contributes to display in a dark environment such as an indoor environment, and the panel provides display by allowing light emitted from the backlight unit 200 to pass through the liquid crystal layer 30. The reflective region R mainly contributes to display in a bright environment such as an outdoor environment, and the panel provides display by reflecting incident light from the outside and allowing the reflected light to pass through the liquid crystal layer 30.

The first substrate 10 includes a first electrode 12 disposed in the transmissive region T and the reflective region R and a second electrode 13 disposed in the transmissive region T. With one first electrode 12 shared by the transmissive region T and the reflective region R, the productivity increases. The first electrode 12 may be a pixel electrode or a common electrode.

The first substrate 10 may be an active matrix substrate (TFT substrate). The TFT substrate can be one usually used in the field of liquid crystal display devices. The TFT substrate has, in a plan view thereof, a configuration such as that shown in FIG. 3 and FIG. 4, which includes parallel gate signal lines 61 disposed on a transparent substrate; parallel source signal lines 62 that extend in the direction perpendicular to the gate signal lines 61; active elements such as TFTs 63 that are disposed at the respective intersections of the gate signal lines 61 and the source signal lines 62; and regions (pixels) defined by the gate signal lines 61 and the source signal lines 62 and formed in a matrix pattern. When a TFT 63 is turned on, a drain line 64 connected to the TFT 63 is electrically connected to the first electrode 12. The liquid crystal display panel 100 preferably includes a transmissive region T and a reflective region R in each pixel.

As shown in FIG. 3 and FIG. 4, the first electrode 12 includes one or more first linear electrode portions 12a in each transmissive region T. In Embodiment 1, the first electrode 12 includes one or more second linear electrode portions 12b in each reflective region R. FIG. 5 includes schematic plan views showing exemplary shapes of a first electrode. FIG. 5(a) is a schematic plan view of a basic electrode structure in Embodiment 1. As shown in FIG. 5(a), the first linear electrode portions 12a and the second linear electrode portions 12b may be disposed with extension directions thereof being perpendicular to each other. When voltage is applied to the liquid crystal layer 30, the alignment of liquid crystal molecules is disrupted in portions where the first linear electrode portions 12a are connected and portions where the second linear electrode portions 12b are connected (portions surrounded by dotted lines), and the transmittance in one pixel decreases. In order to avoid such a case, as shown in FIG. 5(b), the second linear electrode portions 12b are further extended such that the portions where the second linear electrode portions 12b are connected overlap the black matrix described below. This configuration further increases the transmittance of one pixel. In FIG. 5(c), the width of the portions where the second linear electrode portions 12b are connected is reduced. This configuration reduces alignment disorder of the liquid crystal molecules.

The liquid crystal display device provides white display in the reflective region R by aligning the liquid crystal molecules at an azimuth parallel or perpendicular to the polarization axis with voltage applied and reflecting incident light (linearly polarized light) from the outside on the surface of a reflector 15 with the linear polarization maintained. With the first linear electrode portions 12a and the second linear electrode portions 12b being disposed with the extension directions thereof being perpendicular to each other, the direction of the electric field generated in the reflective region R can be perpendicular to the direction of the electric field generated in the transmissive region T such that upon application of voltage, the liquid crystal molecules in the reflective region R are aligned at an azimuth parallel or perpendicular to the polarization axis of a first polarizer 60 or a second polarizer 70. Upon application of voltage, the alignment azimuth of the liquid crystal molecules and the polarization axis of the polarizer may form an angle of 0° or an angle of 0° to 30° from the 0° point in the clockwise or counterclockwise direction. Two azimuths “being perpendicular” as used herein may be two azimuths forming an angle of 90° or an angle of 0° to 30° from the 90° point in the clockwise or counterclockwise direction.

The first linear electrode portions 12a may have a width (L) of 1.5 μm or smaller or 3.8 μm or greater. The liquid crystal display device may have an L/S ratio between the width (L) of the first linear electrode portions 12a and the distance (S) between adjacent first linear electrode portions 12a of 0.1 to 0.4 or 1.7 to 4. The L/S ratio is a value obtained by dividing the width (L) of the first linear electrode portions 12a by the distance (S) between adjacent first linear electrode portions 12a.

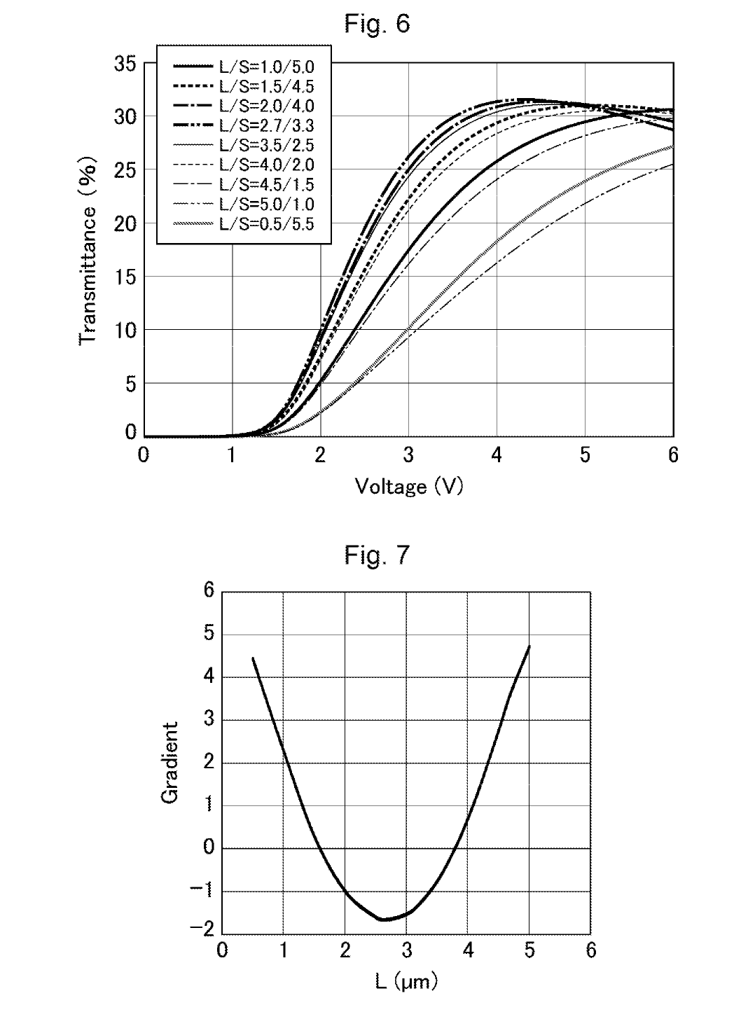

The present inventors have studied the ratio between the width (L) of the first linear electrode portions 12a and the distance (S) between adjacent first linear electrode portions 12a in order to increase the transmittance in white display in the transmissive region T. First, they set the formula: the width (L) of the first linear electrode portions 12a+the distance (S) between adjacent first linear electrode portions 12a=6 μm, and simulated the transmittance by varying L and S values. FIG. 6 is a graph showing the transmittance in the transmissive region versus applied voltage with various widths of the first linear electrode portions and various distances between the first linear electrode portions. The horizontal axis shows the voltage (V) applied to the liquid crystal layer, and the vertical axis shows the transmittance (%) in the transmissive region T. The simulation was performed using liquid crystal molecules having an anisotropy (Δε) of dielectric constant of 7 and a refractive index anisotropy (Δn) of 1.02 and a liquid crystal layer having a thickness (d) of 340 nm. Here, the expected voltage for white display (hereinafter, also referred to as “white expected voltage”) was set to 5 V, and the voltage was designed to monotonically increase up to 5 V.

Based on the results shown in FIG. 6, the gradient of the voltage-transmittance curve in the case with a white expected voltage of 5 V was plotted as shown in FIG. 7. FIG. 7 is a graph showing the gradient of the voltage-transmittance curve at 5 V. The horizontal axis shows the width (L) of the first linear electrode portions 12a and the vertical axis shows the gradient of the voltage-transmittance curve shown in FIG. 6. FIG. 7 shows that the gradient of the voltage-transmittance curve monotonically increased when the first linear electrode portions 12a had a width (L) of 1.5 μm or smaller or 3.8 μm or greater. With no monotonic increase in the gradient of the voltage-transmittance curve, the transmittance may decrease as the voltage increases, causing brightness inversion and poor display quality.

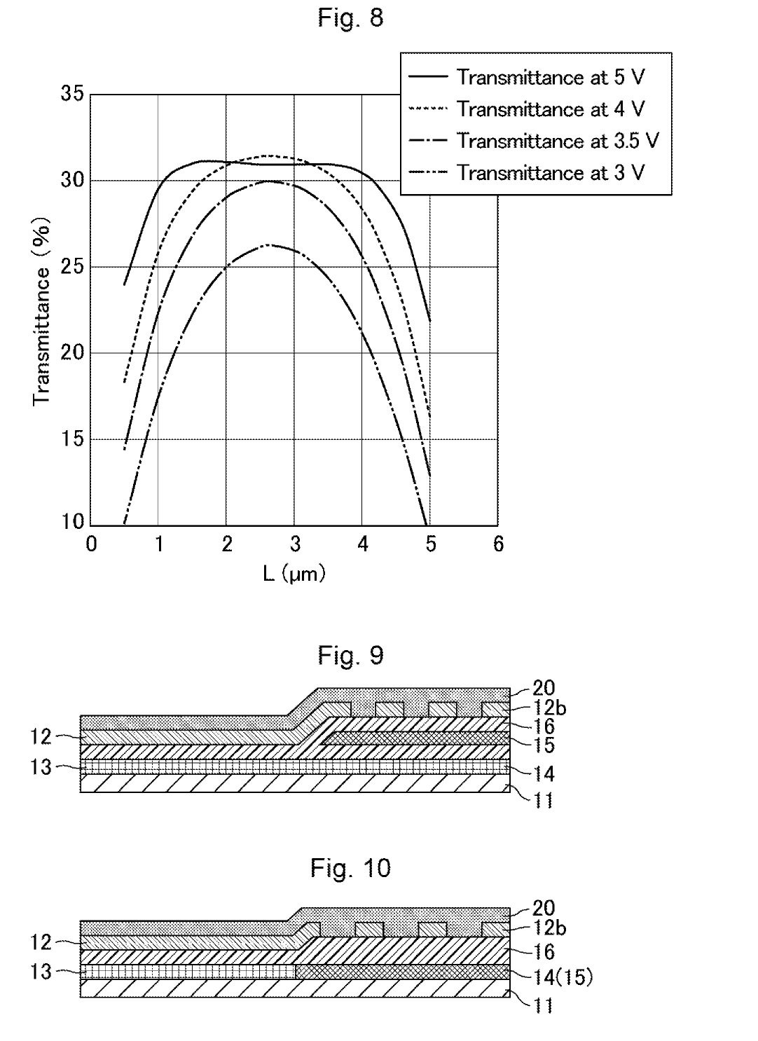

The conditions to achieve a transmittance of 25% or higher were then studied. FIG. 8 is a graph showing changes in transmittance (%) versus width (L) of the first linear electrode portions. FIG. 8 shows that in order to achieve a transmittance of 25% or higher with a white expected voltage of 5 V, the first linear electrode portions 12a need to have a width (L) of 0.6 μm to 4.8 μm. The results shown in FIG. 7 and FIG. 8 show that in order to achieve a monotonic increase in the gradient of the voltage-transmittance curve until the applied voltage reaches 5 V and achieve a transmittance of 25% or higher, a condition is preferred in which L is 0.6 μm to 1.5 μm and S is 4.5 μm to 5.4 μm or L is 3.8 μm to 4.8 μm and S is 1.2 μm to 2.2 μm. FIG. 8 also shows that in order to achieve a transmittance of 25% or higher, when L+S=6 μm holds and the white expected voltage is 4 V, L is preferably 0.9 μm to 4.4 μm and S is preferably 1.6 μm to 5.1 μm. When the white expected voltage is 3.5 V, L is preferably 1.3 μm to 4.1 μm and S is preferably 1.9 μm to 4.7 μm. When the white expected voltage is 3 V, L is preferably 2 μm to 3.4 μm and S is preferably 2.6 μm to 4 μm. In other words, the L/S ratio between the width (L) of the first linear electrode portions and the distance (S) between adjacent first linear electrode portions is preferably 0.1 to 0.4 or 1.7 to 4.

The second linear electrode portions 12b may have any width (L), and the width (L) may be the same as or different from the width (L) of the first linear electrode portions 12a. Also, in the reflective region R, the gradient of the voltage-transmittance curve monotonically increases until the white expected voltage reaches 5 V regardless of the combination of the width (L) of the second linear electrode portions 12b and the distance (S) between adjacent second linear electrode portions 12b. The L/S ratio here therefore may be any value.

In Embodiment 1, the first substrate 10 includes a third electrode 14 in the reflective region R. In Embodiment 1, the second electrode 13 and the third electrode 14 are connected to each other and form one electrode. The second electrode 13 and the third electrode 14 may each be a pixel electrode or a common electrode. In the case where the second electrode 13 and the third electrode 14 are each a common electrode, the first electrode 12 is a pixel electrode. In the case where the second electrode 13 and the third electrode 14 are each a pixel electrode, the first electrode 12 is a common electrode. In Embodiment 1, the liquid crystal display device can provide display in a horizontal alignment mode both in the transmissive region T and the reflective region R.

The second electrode 13 and the third electrode 14 may be formed on the transparent substrate 11 as shown in FIG. 1 and FIG. 2. In the transmissive region T, the first electrode 12 and the second electrode 13 are stacked with the insulating layer 16 in between, and the second electrode 13 may be a planar electrode. In other words, the transmissive region T may have the FFS mode electrode arrangement. Also, in the transmissive region T, the first electrode 12 and the second electrode 13 are formed on the same insulating layer, the second electrode 13 may include one or more fourth linear electrode portions 13a, and the first linear electrode portions 12a and the fourth linear electrode portions 13a may be disposed to face each other. In other words, the transmissive region T may have the IPS mode electrode arrangement.

Likewise, in the reflective region R, the first electrode 12 and the third electrode 14 may be stacked with the insulating layer 16 in between and the third electrode 14 may be a planar electrode. In other words, the reflective region R may have the FFS mode electrode arrangement. Also, in the reflective region R, the first electrode 12 and the third electrode 14 may be formed on the same insulating layer and the third electrode 14 may include one or more third linear electrode portions 14a, and the second linear electrode portions 12b and the third linear electrode portions 14a may be disposed to face each other. In other words, the reflective region R may have the IPS mode electrode arrangement.

With the transmissive region T and/or the reflective region R being in a horizontal alignment mode such as the FFS mode or the IPS mode, the liquid crystal display device can exhibit favorable viewing angle characteristics.

In the case where the transmissive region T is in the FFS mode, the first linear electrode portions 12a may have a width (L) of 1.5 μm or smaller or 3.8 μm or greater. The ratio between the width (L) of the first linear electrode portions 12a and the distance (S) between adjacent first linear electrode portions 12a may be 0.1 to 0.4 or 1.7 to 4.

The first electrode 12, the second electrode 13, and the third electrode 14 may each be a transparent electrode that can be formed of, for example, a transparent conductive material such as indium tin oxide (ITO), indium zinc oxide (IZO), zinc oxide (ZnO), or tin oxide (SnO), or an alloy thereof.

The first substrate 10 may include the reflector 15 in the reflective region R. The reflector 15 emits incident light from the outside through the liquid crystal layer 30 to the outside again through the liquid crystal layer 30, so that white display is achieved. The reflector 15 may be any reflector that can reflect light incident on the reflective region R from the outside. The reflector 15 may be, for example, a reflective plate having a reflective structure on the surface or a thin film of a metal such as silver or aluminum. The reflector 15 may be disposed on the surface of the third electrode 14 close to the backlight unit 200 as shown in FIG. 1 and FIG. 2. In this case, an insulating layer 17 may be formed on the transparent substrate 11 in the reflective region R, the reflector 15 may be disposed on the insulating layer 17, and the third electrode 14 may be stacked on the reflector 15. Also, the reflector 15 may be disposed on the transparent substrate 11 in the reflective region R, the insulating layer 17 may be formed on the reflector 15, and the third electrode 14 may be stacked on the insulating layer 17.

Adjusting the thickness of the insulating layer 17 allows adjustment of the thickness of the liquid crystal layer 30 both in the transmissive region T and the reflective region R. The insulating layer 17 may be formed of, for example, a material containing an organic material. Examples of the organic material include acrylic compounds, polyimide, and polycarbonate. The insulating layer 17 may have an uneven shape on its surface close to the reflector 15. This configuration gives an uneven pattern to the surface of the reflector 15 close to the liquid crystal layer 30, so that the reflector 15 can efficiently reflect incident light from the outside.

FIG. 9 and FIG. 10 are each a schematic cross-sectional view of an exemplary configuration of the first substrate 10. As shown in FIG. 9, the reflector 15 may be disposed between the first electrode 12 and the third electrode 14. In this case, the reflector 15, if being in an electrically floating state, does not affect the electric field generated between the first electrode 12 and the third electrode 14. The reflector 15 is therefore preferably formed to be surrounded by the insulating layer 16. Also, the reflector 15 may be a thin film of a metal such as silver or aluminum formed on the third electrode 14. Furthermore, as shown in FIG. 10, the reflector 15 may be a reflective electrode. The third electrode 14 may be formed of a reflective metal such as silver or aluminum and utilized as the reflector 15.

With no voltage applied to the liquid crystal layer 30, the liquid crystal molecules in the transmissive region T form a twist angle θ1 of 0° or greater and smaller than 30° and the liquid crystal molecules in the reflective region R form a twist angle θ2 of 30° or greater and 80° or smaller. The “twist angle θ1” formed by the liquid crystal molecules in the transmissive region T means the angle formed by the alignment azimuth of liquid crystal molecules adjacent to the first alignment film 20 in the transmissive region T and the alignment azimuth of liquid crystal molecules adjacent to the second alignment film 40 in the transmissive region T. Also, the “twist angle θ2” formed by the liquid crystal molecules in the reflective region R means the angle formed by the alignment azimuth of liquid crystal molecules adjacent to the first alignment film 20 in the reflective region R and the alignment azimuth of liquid crystal molecules adjacent to the second alignment film 40 in the reflective region R. In the transmissive region T, liquid crystal molecules adjacent to the first alignment film 20 and liquid crystal molecules adjacent to the second alignment film 40 are aligned parallel to each other. In the reflective region R, liquid crystal molecules adjacent to the first alignment film 20 and liquid crystal molecules adjacent to the second alignment film 40 are twist-aligned. This configuration can provide display without any in-cell retarder in the reflective region R while avoiding brightness inversion between the transmissive region T and the reflective region R, increasing the productivity. Furthermore, the alignment azimuth of liquid crystal molecules adjacent to the first alignment film 20 in the reflective region R and the alignment azimuth of liquid crystal molecules adjacent to the second alignment film 40 in the reflective region R form an angle θ2 of 30° or greater and 80° or smaller. This configuration can provide display while avoiding brightness inversion between the transmissive region T and the reflective region R even when the thickness of the liquid crystal layer in the reflective region R is half or more of the thickness of the liquid crystal layer in the transmissive region T. As a result, the liquid crystal molecules are allowed to move more dynamically, current leakage can be reduced between the upper and lower substrates, and the productivity is increased.

The alignment azimuth of liquid crystal molecules adjacent to the first alignment film 20 and the alignment azimuth of liquid crystal molecules adjacent to the second alignment film 40 with no voltage applied to the liquid crystal layer 30 depend on the alignment treatment on the first alignment film 20 and the second alignment film 40, respectively. The alignment treatment is preferably photo-alignment treatment which applies light (electromagnetic waves) such as ultraviolet light or visible light in the case where the first alignment film 20 and the second alignment film 40 are photo-alignment films.

The first alignment film 20 and the second alignment film 40 may each be a photo-alignment film formed of a photo-alignment material. The photo-alignment material encompasses general materials that undergo a structural change when irradiated with light (electromagnetic waves), and thereby exhibit an ability (alignment controlling force) of controlling the alignment of liquid crystal molecules adjacent to the photo-alignment film or change the alignment control force level and/or direction. Examples of the photo-alignment material include those containing a photo-reactive site which undergoes a reaction such as dimerization (formation of dimers), isomerization, photo-Fries rearrangement, or decomposition when irradiated with light. Examples of the photo-reactive site (functional group) which is dimerized and isomerized when irradiated with light include cinnamate, 4-chalcone, 4′-chalcone, coumarin, and stilbene. Examples of the photo-reactive site (functional group) which is isomerized when irradiated with light include azobenzene. Examples of the photo-reactive site which is photo-Fries rearranged when irradiated with light include phenolic ester structures. Examples of the photo-reactive site which is decomposed when irradiated with light include cyclobutane structures.

With no voltage applied to the liquid crystal layer 30, the alignment azimuth of liquid crystal molecules adjacent to the first alignment film 20 in the reflective region R or the alignment azimuth of liquid crystal molecules adjacent to the second alignment film 40 in the reflective region R is parallel to the alignment azimuth of liquid crystal molecules adjacent to the first alignment film 20 in the transmissive region T. With this configuration, only one of the first alignment film 20 and the second alignment film 40 needs to be subjected to alignment division treatment, so that the productivity is increased. This configuration also reduces defects due to misalignment of the first substrate 10 and the second substrate 50 during bonding of the substrates to each other.

In the photo-alignment treatment, alignment division is achieved by, for example, irradiating one of the first alignment film 20 and the second alignment film 40 with light from different azimuths for the transmissive region T and the reflective region R. The other of the first alignment film 20 and the second alignment film 40 that is not subjected to the alignment division treatment can be irradiated with light from the same azimuth for the transmissive region T and the reflective region R.

Specific examples of the alignment division treatment include performing first light irradiation on the regions corresponding to the transmissive region T while shielding the regions of the first alignment film 20 or the second alignment film 40 corresponding to the reflective region R from light with a mask formed of a light-shielding material, followed by second light irradiation on the regions corresponding to the reflective region R while shielding the regions corresponding to the transmissive region T from light with the mask. The specific examples of the alignment division treatment also include a method using a wire grid polarizer. A wire grid polarizer includes an optically transparent substrate and thin metal lines formed on the optically transparent substrate, and the thin metal lines are disposed at a pitch shorter than the wavelength of light incident on the wire grid polarizer. The thin metal lines are formed of, for example, a light-absorbing metal material such as chromium. When the first alignment film 20 or the second alignment film 40 is irradiated with light with the wire grid polarizer stacked thereon, the liquid crystal molecules are aligned at an azimuth perpendicular to the extension azimuth of the thin metal lines. Hence, the alignment division treatment can be performed by applying light only once using a wire grid polarizer in which thin metal lines extend at different azimuths in the regions corresponding to the transmissive region T and the regions corresponding to the reflective region R. This alignment division treatment therefore increases the productivity.

The liquid crystal display panel 100 may include the first polarizer 60 disposed on the surface of the first substrate 10 remote from the liquid crystal layer 30 and the second polarizer 70 disposed on the surface of the second substrate 50 remote from the liquid crystal layer 30. The first polarizer 60 and the second polarizer 70 are disposed with the polarization axes thereof being perpendicular to each other. With no voltage applied to the liquid crystal layer 30, the alignment azimuth of liquid crystal molecules adjacent to the first alignment film 20 in the transmissive region T and the alignment azimuth of liquid crystal molecules adjacent to the second alignment film 40 in the transmissive region T are preferably parallel to the polarization axis of the first polarizer 60 or the second polarizer 70.

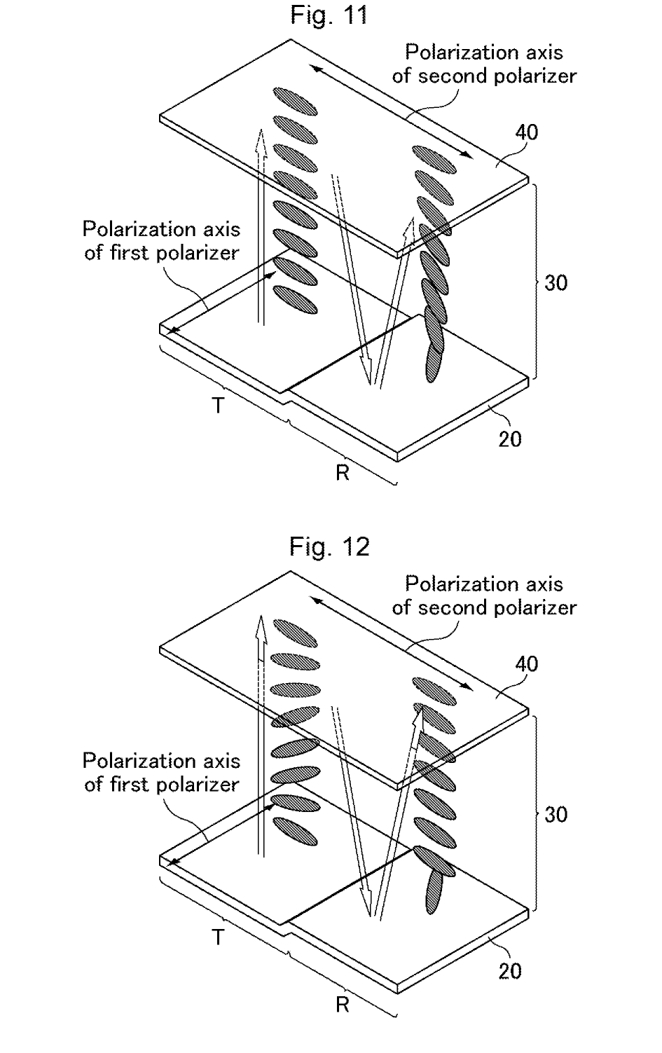

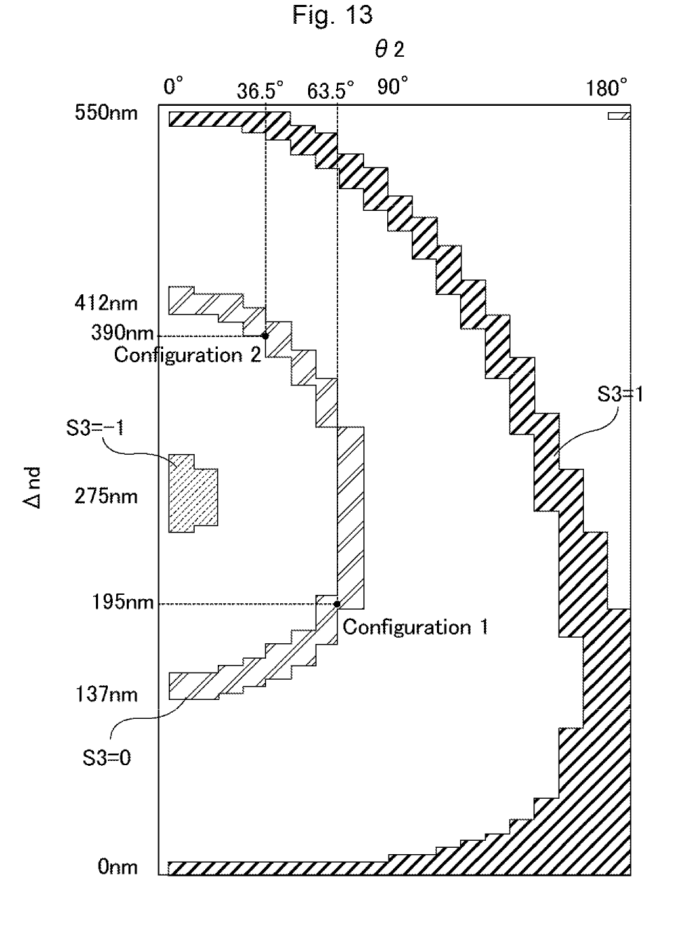

The liquid crystal display device 1000 may be in the normally black mode which provides black display with no voltage applied to the liquid crystal layer 30 and provides white display with voltage applied to the liquid crystal layer 30. The white display and the black display in the normally black mode are described with reference to FIG. 3, FIG. 4, FIG. 11, and FIG. 12. FIG. 11 and FIG. 12 are a perspective view of the liquid crystal display device shown in FIG. 1 with no voltage applied and a perspective view of the liquid crystal display device with voltage applied, respectively. FIG. 11 and FIG. 12 show only parts of the display device, namely the first alignment film 20, the second alignment film 40, and the liquid crystal layer 30.

As shown in FIG. 3 and FIG. 11, with no voltage applied, liquid crystal molecules adjacent to the first alignment film 20 and liquid crystal molecules adjacent to the second alignment film 40 in the transmissive region T are parallel to each other and aligned at an azimuth parallel to the polarization axis of the second polarizer 70. Liquid crystal molecules present in the thickness direction of the liquid crystal layer 30 in the transmissive region T are aligned parallel to liquid crystal molecules adjacent to the first alignment film 20 and liquid crystal molecules adjacent to the second alignment film 40, so that the device provides black display. In the reflective region R, liquid crystal molecules adjacent to the first alignment film 20 and liquid crystal molecules adjacent to the second alignment film 40 form an angle θ2, exhibiting twist alignment. Liquid crystal molecules present in the thickness direction of the liquid crystal layer 30 in the reflective region R are aligned along the twist between the liquid crystal molecules adjacent to the first alignment film 20 and the liquid crystal molecules adjacent to the second alignment film 40. In the reflective region R, the device provides black display by converting incident light from the outside into circularly polarized light and reflecting the circularly polarized light.

As shown in FIG. 4 and FIG. 12, with voltage applied, liquid crystal molecules adjacent to the first alignment film 20, liquid crystal molecules adjacent to the second alignment film 40, and liquid crystal molecules present in the thickness direction of the liquid crystal layer 30 in the transmissive region T are rotated by a horizontal electric field generated between the first electrode 12 and the second electrode 13. The alignment azimuths of the liquid crystal molecules are shifted from the azimuth parallel or perpendicular to the polarization axis of the first polarizer 60 or the second polarizer 70 as shown in FIG. 12 and form, for example, an angle of 45° with the polarization axis, so that the device provides white display. In the reflective region R, liquid crystal molecules adjacent to the first alignment film 20, liquid crystal molecules adjacent to the second alignment film 40, and liquid crystal molecules present in the thickness direction of the liquid crystal layer 30 are rotated by a horizontal electric field generated between the first electrode 12 and the third electrode 14 and aligned parallel to the polarization axis of the second polarizer 70. In the reflective region R, the device provides white display by reflecting incident light (linearly polarized light) from the outside having passed through the second polarizer 70.

With no voltage applied to the liquid crystal layer 30, the alignment azimuth of liquid crystal molecules adjacent to the first alignment film 20 in the reflective region R and the alignment azimuth of liquid crystal molecules adjacent to the second alignment film 40 in the reflective region preferably form an angle θ2 (hereinafter, also referred to as a “twist angle”) of 32° or greater and 41° or smaller or 59° or greater and 68° or smaller. In Embodiment 1, the angle 92 is 59° or greater and 68° or smaller. Also in Embodiment 1, the liquid crystal retardation value (Δnd) represented by the following formula (1) is more preferably 170 nm or more and 220 nm or less. A particularly preferred configuration in Embodiment 1 is that the angle θ2 is 63.5° and the liquid crystal retardation value is 195 nm (Configuration 1). The angle θ2 is 32° or greater and 41° or smaller in the later-described Embodiment 2. In Embodiment 2, the liquid crystal retardation value (Δnd) represented by the following formula (1) in the reflective region R is more preferably 375 nm or more and 405 nm or less. A particularly preferred configuration in Embodiment 2 is that the angle θ2 is 36.5° and the liquid crystal retardation value in the reflective region R is 390 nm (Configuration 2). The liquid crystal retardation value (Δnd) is represented by the following formula (1).

Liquid crystal retardation value (Δnd)=anisotropy (Δn) of dielectric constant of liquid crystal molecules×thickness (d) of liquid crystal layer Formula (1)

The present inventors studied the optimal combination of the angle θ2 and the liquid crystal retardation value in the reflective region R. In the reflective region R, the device can provide black display by converting incident light (linearly polarized light) from the outside into circularly polarized light on the surface of the reflector 15. Based on this configuration, the inventors studied the conditions where circularly polarized light incident on and having passed through the liquid crystal layer is converted into linearly polarized light. They used liquid crystal molecules having an anisotropy (Δε) of dielectric constant of 7 and a refractive index anisotropy (Δn) of 1.02, set the width (L) of the second linear electrode portions 12b to 2.7 μm and the distance (S) between adjacent second linear electrode portions 12b to 3.3 μm, and employed LCDMaster from Shintec, Inc. FIG. 13 is a simulation view showing the relationship between a liquid crystal retardation value and a twist angle in the reflective region. FIG. 13 shows the values of emitted light when circularly polarized light (S3=1) is incident on the liquid crystal layer 30 in the reflective region R, with the vertical axis showing the liquid crystal retardation value (Δnd) and the horizontal axis showing the angle θ2. When S3 is 0, circularly polarized light incident on the reflective region is emitted as linearly polarized light, so that the device can provide black display with no voltage applied.

In the case where the angle θ2 is 59° or greater and 68° or smaller and the liquid crystal retardation value (Δnd) represented by the above formula (1) is 170 nm or more and 220 nm or less, the alignment azimuth of liquid crystal molecules adjacent to the second alignment film 40 in the reflective region R is preferably parallel to the alignment azimuth of liquid crystal molecules adjacent to the second alignment film 40 in the transmissive region T. The results in FIG. 13 show that Configuration 1 and Configuration 2 correspond to the configurations in which the alignment azimuth of liquid crystal molecules adjacent to the first alignment film 20 in the reflective region R or the alignment azimuth of liquid crystal molecules adjacent to the second alignment film 40 in the reflective region R forms an angle of 0° or 90° with the polarization axis of the first polarizer 60 or the second polarizer 70.

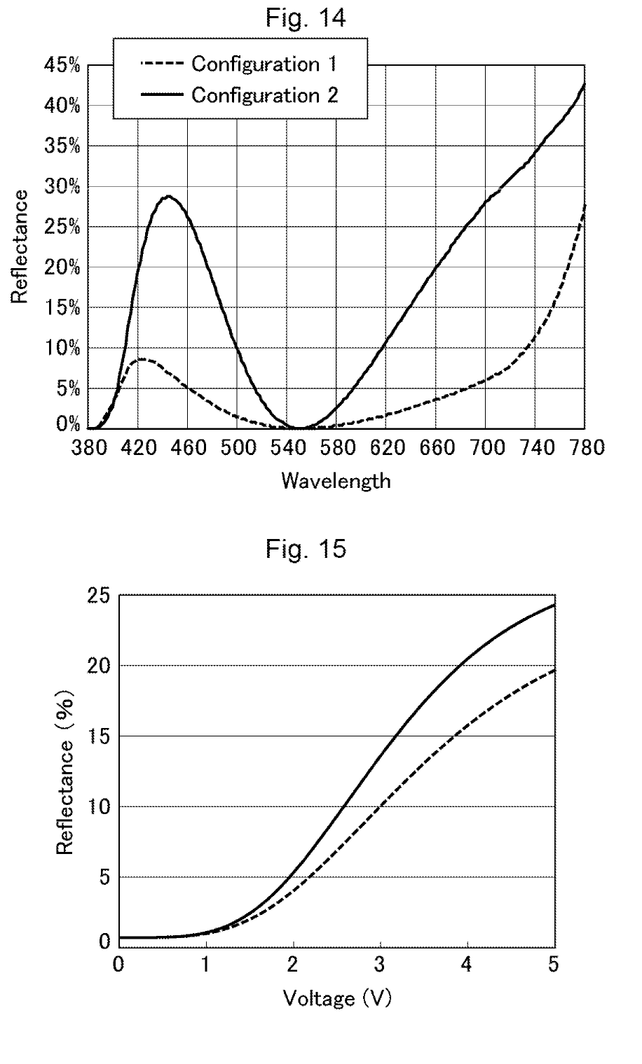

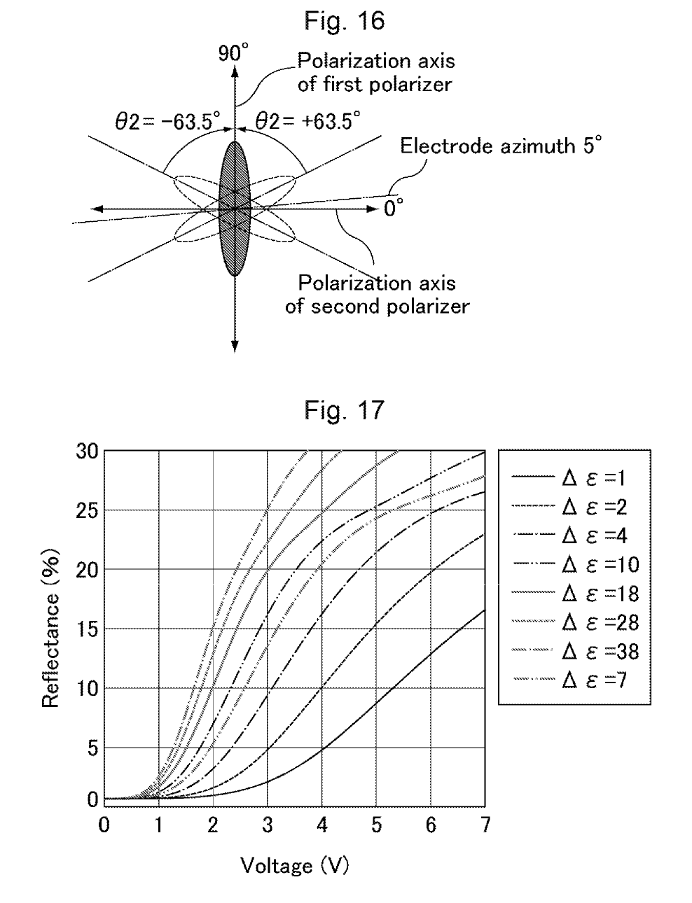

FIG. 14 is a graph comparing the reflectance values in the reflective region in Configuration 1 and Configuration 2. The horizontal axis shows the wavelength (nm) and the vertical axis shows the reflectance (%) in the reflective region. The simulation was performed using liquid crystal molecules having an anisotropy (Δε) of dielectric constant of 7 and a refractive index anisotropy (Δn) of 1.02, with a width (L) of the second linear electrode portions 12b of 2.7 μm and a distance (S) between adjacent second linear electrode portions 12b of 3.3 μm. FIG. 14 shows that in comparison between Configuration 1 and Configuration 2, Configuration 1 was found to give a low reflectance value in a wide range. Furthermore, the alignment azimuth of liquid crystal molecules adjacent to the first alignment film 20 in the reflective region R in Configuration 1 was studied relative to the alignment azimuth of liquid crystal molecules adjacent to the second alignment film 40 in the reflective region R. FIG. 15 is a graph comparing changes in reflectance depending on the alignment azimuths of the liquid crystal molecules in Configuration 1. In FIG. 15, the solid line indicates the case where the alignment azimuth of liquid crystal molecules adjacent to the second alignment film 40 in the reflective region R relative to the alignment azimuth of liquid crystal molecules adjacent to the first alignment film 20 in the reflective region R in Configuration 1 was +63.5° and the dashed line indicates the case where it was −63.5°. FIG. 16 is a schematic view illustrating twist angles of a liquid crystal molecule in the reflective region. In FIG. 16, the dotted lines indicate liquid crystal molecules adjacent to the first alignment film 20 in the reflective region R and the solid line indicates a liquid crystal molecule adjacent to the second alignment film 40 in the reflective region R. FIG. 15 shows that in Configuration 1, an alignment azimuth of liquid crystal molecules of +63.5° (the solid line in FIG. 15) gives a higher reflectance value in white display than an alignment azimuth of −63.5° (the dashed line in FIG. 15).

In Embodiment 1, the liquid crystal layer 30 has different thicknesses in the reflective region R and the transmissive region T. In Configuration 1, in the case where the liquid crystal retardation value (Δnd) in the reflective region R is 195 nm and the liquid crystal retardation value (Δnd) in the transmissive region T is 330 nm to 340 nm, which is a typical range, the liquid crystal layer 30 has a smaller thickness in the reflective region R than in the transmissive region T.

The liquid crystal molecules may have an anisotropy (Δε) of dielectric constant of 1.5 to 36. The liquid crystal molecules having an anisotropy (Δε) of dielectric constant of 1.5 to 36 can give a high reflectance value in the reflective region in white display.

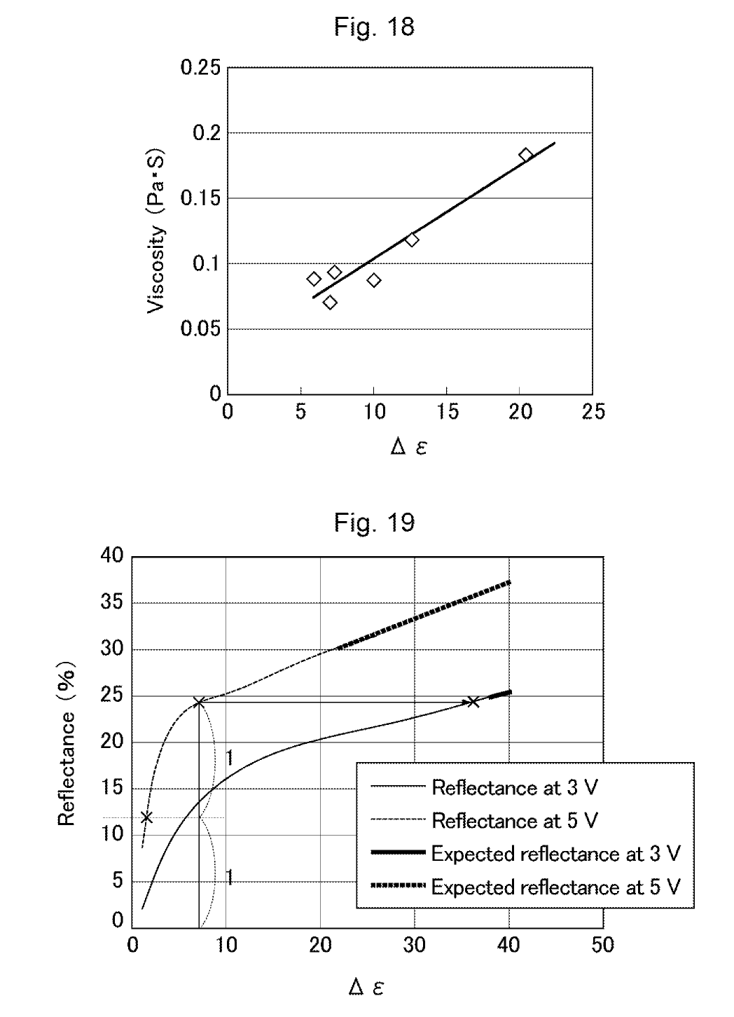

The present inventors considered the upper limit of the anisotropy (Δε) of dielectric constant. FIG. 17 is a graph showing the dependence of the applied voltage and the reflectance on the anisotropy (Δε) of dielectric constant. The horizontal axis shows the voltage (V) applied to the liquid crystal layer and the vertical axis shows the reflectance (%) in the reflective region R. Simulation was performed using liquid crystal molecules having an anisotropy (Δε) of dielectric constant of 7 and a refractive index anisotropy (Δn) of 1.02, with a width (L) of the second linear electrode portions 12b of 2.7 μm and a distance (S) between adjacent second linear electrode portions 12b of 3.3 μm. FIG. 17 shows that the reflectance increases as the anisotropy (Δε) of dielectric constant of the liquid crystal molecules increases. With liquid crystal molecules having an anisotropy (Δε) of dielectric constant of 7, the reflectance monotonically increases relative to the applied voltage, and a reflectance of 24% is achieved at a white expected voltage of 5 V. With liquid crystal molecules having an anisotropy (Δε) of dielectric constant of 20, the reflectance at an applied voltage of 5 V is 29%, which is higher than the reflectance in the case of liquid crystal molecules having an anisotropy (Δε) of dielectric constant of 7 by as much as 5%. The reflectance in the reflective region increases as the anisotropy (Δε) of dielectric constant increases, and thereby the luminance of the liquid crystal display panel can be high. Meanwhile, the viscosity of liquid crystal molecules typically increases as the anisotropy (Δε) of dielectric constant increases. FIG. 18 is a graph showing the relationship between the anisotropy (Δε) of dielectric constant and the viscosity of liquid crystal molecules. The horizontal axis shows the anisotropy (Δε) of dielectric constant and the vertical axis shows the viscosity (Pa'S). Liquid crystal molecules having a high viscosity may be less movable and exhibit low response performance. FIG. 17 shows that liquid crystal molecules having an anisotropy (Δε) of dielectric constant of 7 give a reflectance of 24% at a white expected voltage of 5V and liquid crystal molecules having an anisotropy (Δε) of dielectric constant of 36 can give an equivalent reflectance at a white expected voltage of 3 V. The upper limit of the anisotropy (Δε) of dielectric constant of the liquid crystal molecules is therefore preferably 36 with which a reflectance of 24% can be achieved.

The lower limit of the anisotropy (Δε) of dielectric constant was then studied. FIG. 19 is a graph showing the reflectance and expected reflectance for white expected voltage levels of 3 V and 5 V. The horizontal axis shows the anisotropy (Δε) of dielectric constant and the vertical axis shows the reflectance (%) in the reflective region R. In many transflective liquid crystal display devices, the transmissive region is considered important and the reflective region is provided to support the transmissive region. Given this, the acceptable reflectance can be half the reflectance (24%) at a white expected voltage of 5 V, i.e., a reflectance of about 12%. FIG. 19 shows that the lower limit of the anisotropy (Δε) of dielectric constant of the liquid crystal molecules is preferably 1.5 with which a reflectance of 12% can be achieved.

The second substrate 50 may be a color filter substrate. Examples of the color filter substrate include a configuration including a light-shielding layer (black matrix) 52 between pixels and a color filter layer 53, for example. The color filter layer 53 may include, for example, a red color filter layer 53R, a green color filter layer 53G, and a blue color filter layer 53B.

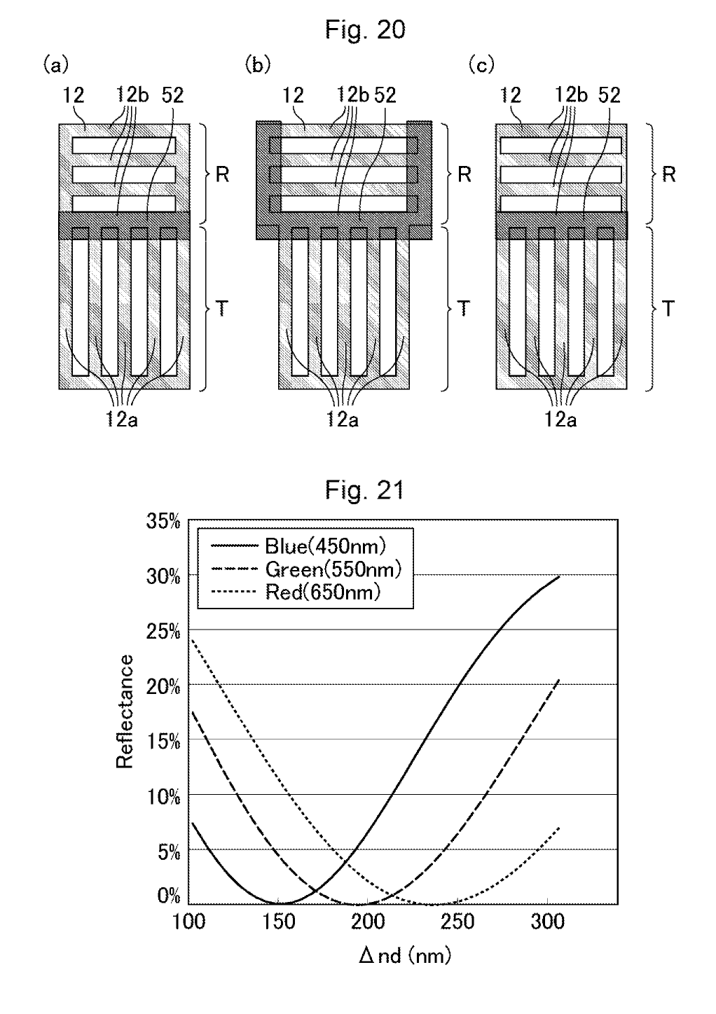

FIG. 20 includes schematic plan views of exemplary arrangements of a light-shielding layer between pixels. As described above, the alignment of liquid crystal molecules is disrupted in portions surrounded by dotted lines in FIG. 5(a) to FIG. 5(c) and thus the transmittance is low. In order to prevent such a case, the black matrix 52 is disposed in regions corresponding to portions where the first linear electrode portions 12a are connected or portions where the second linear electrode portions 12b are connected in a plan view, so that display defects due to the alignment disorder of liquid crystal molecules can be less visible.

The second substrate 50 may include the green, blue, and red color filter layers 53 that face the liquid crystal layer 30 and may satisfy the relation d(B)<d(G)<d(R), where d(G) represents the thickness of the portion of the liquid crystal layer 30 facing the green color filter layer 53G, d(B) represents the thickness of the portion of the liquid crystal layer 30 facing the blue color filter layer 53B, and d(R) represents the thickness of the portion of the liquid crystal layer 30 facing the red color filter layer 53R, in the reflective region R.

The optimal liquid crystal retardation value (Δnd) for black display differs for different colors of the color filters. For this reason, a multi-gap structure can be used which provides different film thicknesses to the green, blue, and red color filters to decrease the reflectance in black display and further reduce generation of coloring. FIG. 21 is a graph showing wavelength dependence of the liquid crystal retardation value and the reflectance. The horizontal axis shows the liquid crystal retardation value (Δnd) and the vertical axis shows the reflectance (%) in the reflective region R. In a simulation performed using liquid crystal molecules having an anisotropy (Δε) of dielectric constant of 7 and a refractive index anisotropy (Δn) of 1.02 with a width (L) of the second linear electrode portions 12b of 2.7 μm and a distance (S) between adjacent second linear electrode portions 12b of 3.3 μm, the most preferred liquid crystal retardation values (Δnd) are a liquid crystal retardation value Δnd(G) of the portion of the liquid crystal layer facing the green color filter of 195 nm, a liquid crystal retardation value Δnd(B) of the portion of the liquid crystal layer facing the blue color filter of 152 nm, and a liquid crystal retardation value Δnd(R) of the portion of the liquid crystal layer facing the red color filter of 237 nm.

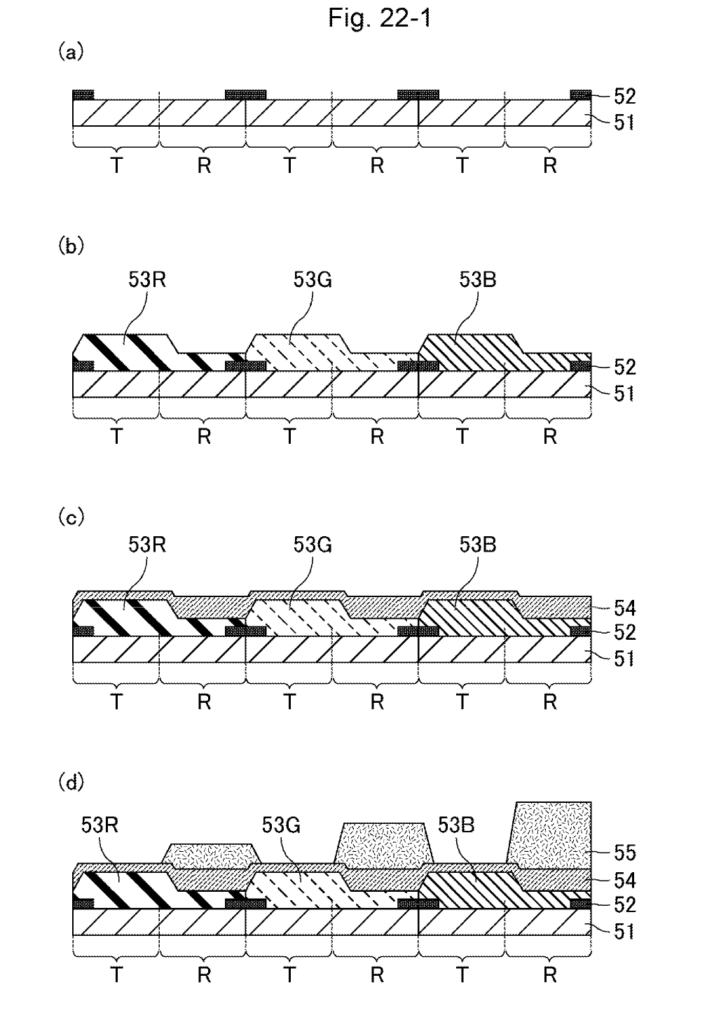

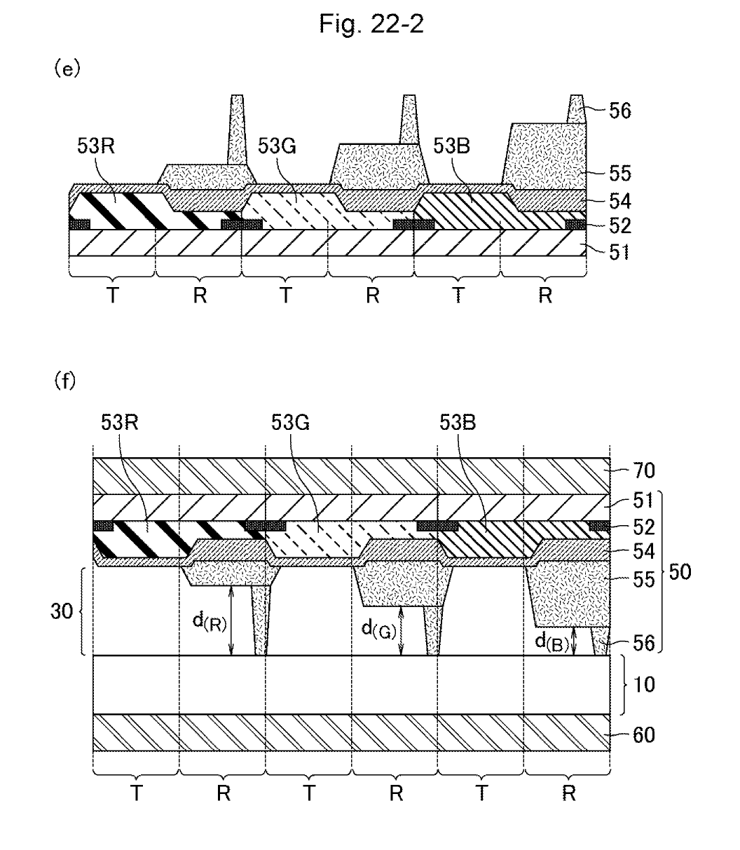

The process of producing the color filter substrate is described with reference to FIG. 22. FIG. 22-1 and FIG. 22-2 include schematic views illustrating an exemplary process of producing color filters. FIG. 22-1 and FIG. 22-2 show the steps of producing color filters for three pixels. As shown in FIG. 22-1(a), the light-shielding layer (black matrix) 52 between pixels is formed on the transparent substrate 51 using a resin containing materials such as a black pigment or a thin metal film, for example. Then, as shown in FIG. 22-1(b), resins containing red, green, and blue color materials (pigments) are applied to the transparent substrate 51 and the black matrix 52, followed by reduction in thickness in the reflective region by half exposure to form the red color filter layer 53R, the green color filter layer 53G, and the blue color filter layer 53B. As shown in FIG. 22-1(c), an overcoat layer 54 is formed on the color filter layers 53. The thickness is preferably the same in the reflective region and the transparent portion, but the sum of the thickness of the color filter layers 53 and the thickness of the overcoat layer 54 may be different in the reflective region and the transparent portion. In addition, as shown in FIG. 22-1(d), a transparent resin is applied to the overcoat layer 54 in the reflective region and the multi-gap layer 55 is formed by half exposure. The thicknesses of the portions of the liquid crystal layer 30 facing the red (R), green (G), and blue (B) color filters can be adjusted by adjusting the thicknesses of the multi-gap layer 55. In order to achieve the transmission contrast of the liquid crystal display panel, the color filter layers 53 each preferably have an inclined surface at the border between the transmissive region T and the reflective region R, and the inclined surface is preferably included in the reflective region R. Then, as shown in FIG. 22-2(e), a photo spacer layer 56 is formed on the multi-gap layer 55 in the reflective region R. The photo spacer layer 56 defines the thickness of the liquid crystal layer 30 and may include a main spacer which is in contact with both the first substrate 10 and the second substrate 50 and a sub spacer which is shorter than the main spacer and is in contact with only one of the first substrate 10 and the second substrate 50. The photo spacer layer 56 may be formed simultaneously with the multi-gap layer 55 in FIG. 22-1(d). As shown in FIG. 22-2(f), when the first substrate 10 and the second substrate 50 are bonded to each other, the thicknesses d(G), d(B), and d(R) of the portions of the liquid crystal layer 30 facing the respective color filters can be differentiated to achieve, for example, the relation d(B)<d(G)<d(R).

The color filter layers 53 may further include a yellow (Y) color filter layer. The yellow (Y) color filter layer may be formed by, as with the case of the red, green, and blue color filter layers, applying a resin containing a yellow color material (e.g., pigment) to the transparent substrate 51 and the black matrix 52. The thickness of the portion of the liquid crystal layer 30 facing the yellow (Y) color filter can be adjusted by adjusting the thickness of the multi-gap layer 55. For example, the relation d(B)<d(G)<d(Y)<d(R) may hold, where d(Y) represents the thickness of the portion of the liquid crystal layer 30 facing the yellow color filter.

Although the liquid crystal retardation value (Δnd) in the reflective region R is adjusted using a structure (insulating layer 17) formed in the first substrate 10 in FIG. 1 and FIG. 2, the liquid crystal retardation value (Δnd) in the reflective region R may be adjusted using a structure formed in the second substrate 50. The structure to be formed in the second substrate 50 is, for example, the multi-gap layer 55.

The backlight unit 200 can be one usually used in the field of liquid crystal display devices. The backlight unit 200 may be a direct-lit one or an edge-lit one which is disposed behind the liquid crystal panel 100 and emits light from the surface of the display device close to the viewer through the transmissive region T of the liquid crystal panel 100.

### Embodiment 2

In Embodiment 2, with no voltage applied to the liquid crystal layer 30, the alignment azimuth of liquid crystal molecules adjacent to the first alignment film 20 in the reflective region R and the alignment azimuth of liquid crystal molecules adjacent to the second alignment film 40 in the reflective region form an angle θ2 of 32° or greater and 41° or smaller. In Embodiment 2, the liquid crystal retardation value (Δnd) represented by the above formula (1) in the reflective region R is more preferably 375 nm or more and 405 nm or less. Here, a particularly preferred configuration is one in which the angle 92 is 36.5° and the liquid crystal retardation value in the reflective region R is 390 nm (Configuration 2).

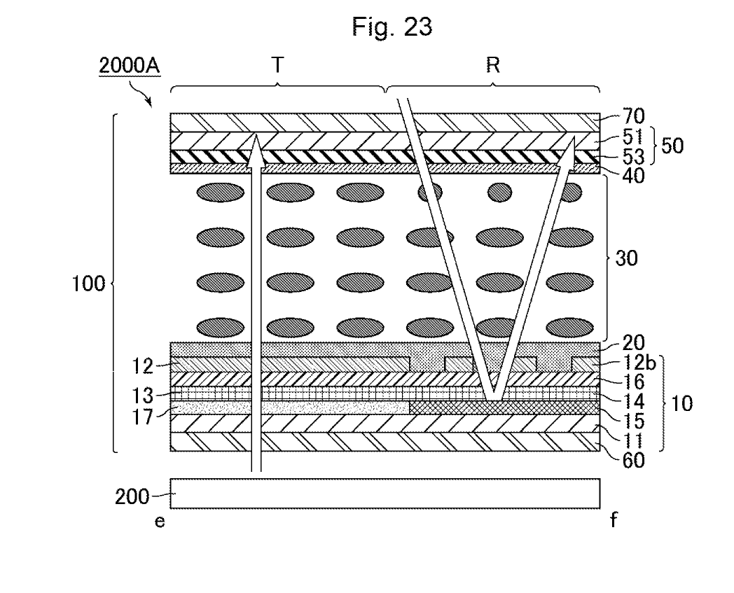

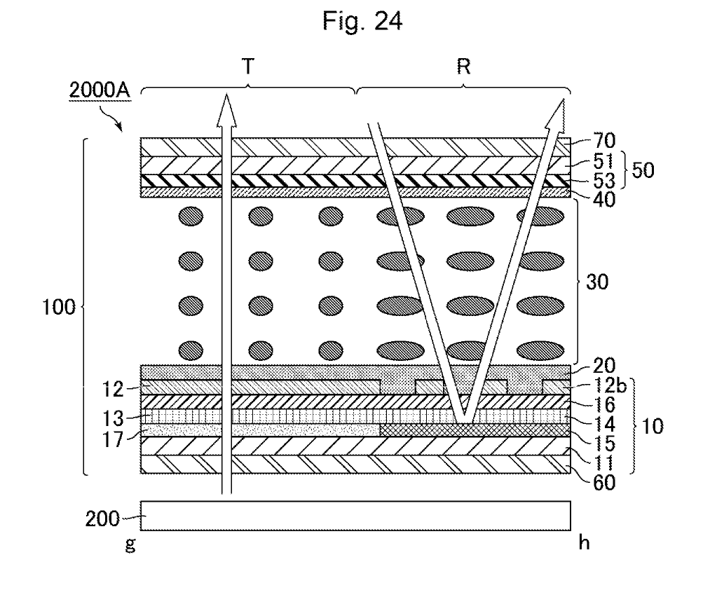

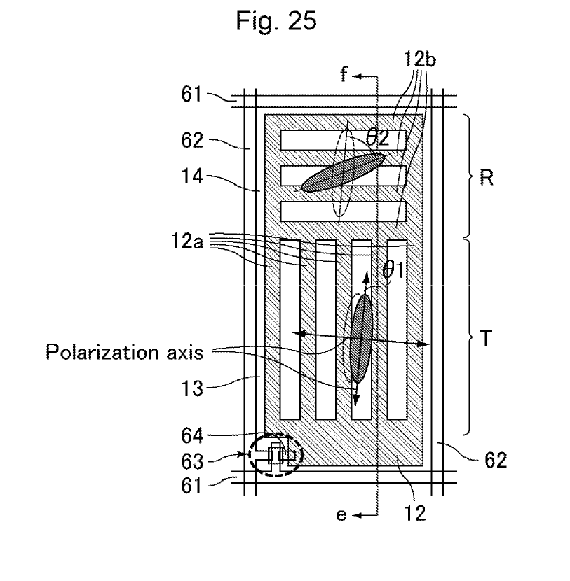

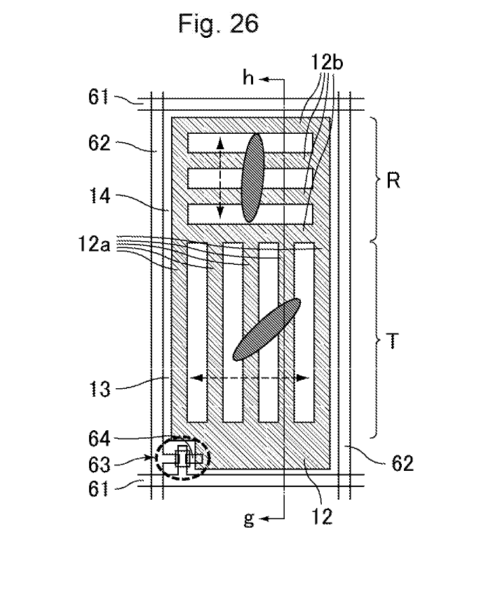

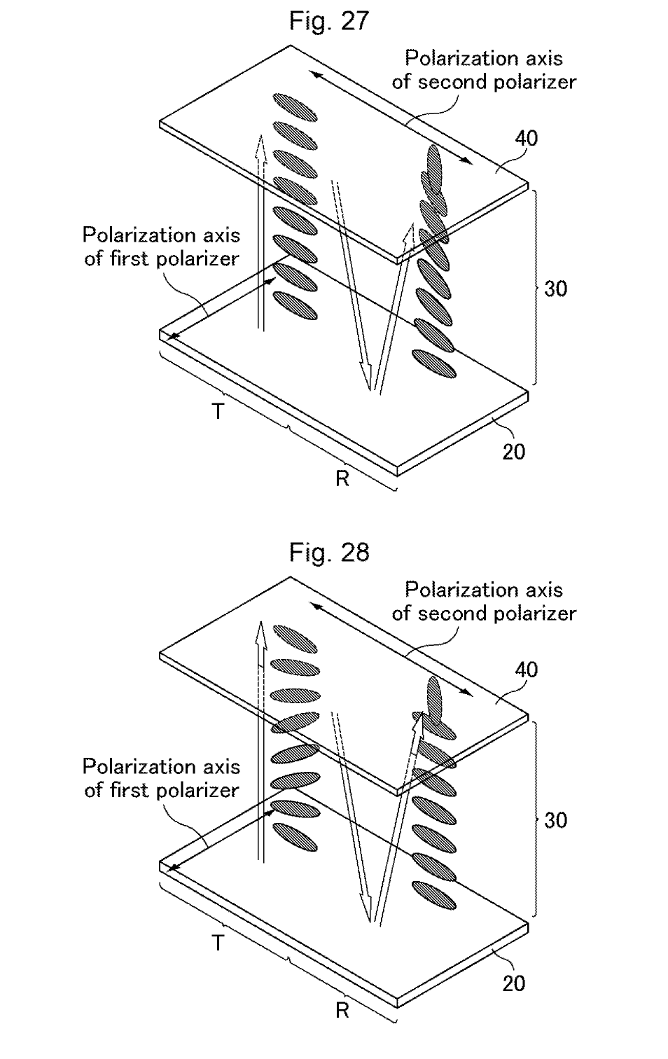

FIG. 23 is a schematic cross-sectional view of an exemplary liquid crystal display device of Embodiment 2 with no voltage applied. FIG. 24 to FIG. 28 are a schematic cross-sectional view of the liquid crystal display device shown in FIG. 23 with voltage applied, a schematic plan view of the liquid crystal display device with no voltage applied, a schematic plan view of the liquid crystal display device with voltage applied, a perspective view of the liquid crystal display device with no voltage applied, and a perspective view of the liquid crystal display device with voltage applied, respectively. FIG. 23 is a cross-sectional view taken along the line e-f in FIG. 25 and FIG. 24 is a cross-sectional view taken along the line g-h in FIG. 26. FIG. 27 and FIG. 28 show only parts of the display device, namely the first alignment film 20, the second alignment film 40, and the liquid crystal layer 30. In FIG. 23 and FIG. 24, the white arrows indicate the paths of light. In FIG. 25, liquid crystal molecules adjacent to the first alignment film 20 are indicated by dotted lines, and liquid crystal molecules adjacent to the second alignment film 40 are indicated by solid lines. In FIG. 26, the double-headed dotted arrows each indicate the direction of an electric field.

A liquid crystal display device 2000A of Embodiment 2 may have an angle θ2 of 32° or greater and 41° or smaller and a liquid crystal retardation value (Δnd) represented by the above formula (1) in the reflective region R of 375 nm or more and 405 nm or less. The alignment azimuth of liquid crystal molecules adjacent to the first alignment film 20 in the reflective region R is preferably parallel to the alignment azimuth of liquid crystal molecules adjacent to the first alignment film 20 in the transmissive region T.

In the liquid crystal display device 2000A, the liquid crystal layer 30 may have the same or different thicknesses in the reflective region R and the transmissive region T. In Configuration 2, since the liquid crystal retardation value (Δnd) in the reflective region R is 390 nm, the liquid crystal layer 30 can be made to have the same thickness in the reflective region R and the transmissive region T by setting the liquid crystal retardation value (Δnd) in the transmissive region T to 390 nm. The “liquid crystal layer 30 may have the same thickness in the reflective region R and the transmissive region T” means that the liquid crystal layer may have substantially the same thickness, with the difference in thickness of the liquid crystal layer 30 between the reflective region R and the transmissive region T being 0 nm to 40 nm.

As shown in FIG. 23, FIG. 25, and FIG. 27, with no voltage applied, liquid crystal molecules adjacent to the first alignment film 20 and liquid crystal molecules adjacent to the second alignment film 40 in the transmissive region T are parallel to each other and aligned at an azimuth parallel to the polarization axis of the second polarizer 70. Liquid crystal molecules present in the thickness direction of the liquid crystal layer 30 in the transmissive region T are aligned parallel to the liquid crystal molecules adjacent to the first alignment film 20 and the liquid crystal molecules adjacent to the second alignment film 40, so that the device provides black display. In the reflective region R, liquid crystal molecules adjacent to the first alignment film 20 and liquid crystal molecules adjacent to the second alignment film 40 form an angle θ2, exhibiting twist alignment. Liquid crystal molecules present in the thickness direction of the liquid crystal layer 30 in the reflective region R are aligned along the twist between the liquid crystal molecules adjacent to the first alignment film 20 and the liquid crystal molecules adjacent to the second alignment film 40. In the reflective region R, the device provides black display by converting incident light from the outside into circularly polarized light and reflecting the circularly polarized light.

As shown in FIG. 24, FIG. 26, and FIG. 28, with voltage applied, liquid crystal molecules adjacent to the first alignment film 20, liquid crystal molecules adjacent to the second alignment film 40, and liquid crystal molecules present in the thickness direction of the liquid crystal layer 30 in the transmissive region T are rotated by a horizontal electric field generated between the first electrode 12 and the second electrode 13. The alignment azimuths of the liquid crystal molecules are shifted from the azimuth parallel or perpendicular to the polarization axis of the first polarizer 60 or the second polarizer 70 as shown in FIG. 28 and form, for example, an angle of 45° with the polarization axis, so that the device provides white display. In the reflective region R, liquid crystal molecules adjacent to the first alignment film 20, liquid crystal molecules adjacent to the second alignment film 40, and liquid crystal molecules present in the thickness direction of the liquid crystal layer 30 are rotated by a horizontal electric field generated between the first electrode 12 and the third electrode 14 and aligned parallel to the polarization axis. In the reflective region R, the device provides white display by reflecting incident light (linearly polarized light) from the outside having passed through the second polarizer 70.

### Modified Example 1 of Embodiment 2

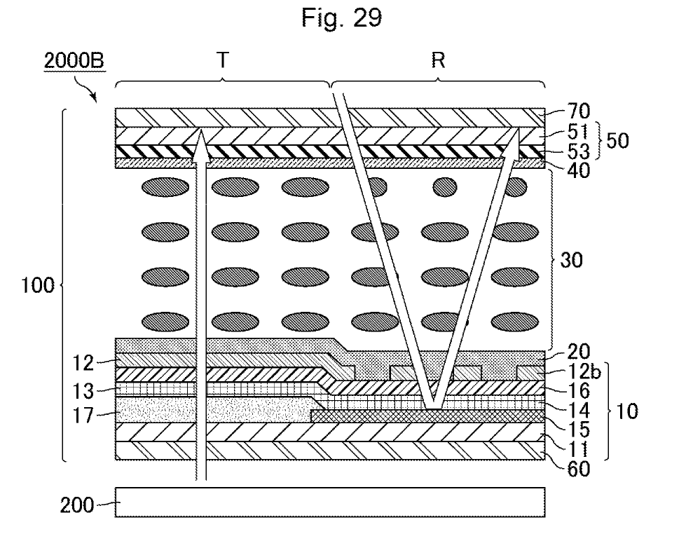

FIG. 29 is a schematic cross-sectional view of an exemplary liquid crystal display device of Modified Example 1 of Embodiment 2 with no voltage applied. In a liquid crystal display device 2000B of Modified Example 1 of Embodiment 2, the liquid crystal layer 30 has different thicknesses in the reflective region R and the transmissive region T. As shown in FIG. 29, in the liquid crystal display device 2000B, the liquid crystal layer 30 has a greater thickness in the reflective region R than in the transmissive region T. In Configuration 2, since the liquid crystal retardation value (Δnd) is 330 nm to 340 nm, which is a typical range, the liquid crystal layer 30 has a greater thickness in the reflective region R than in the transmissive region T.

### Embodiment 3

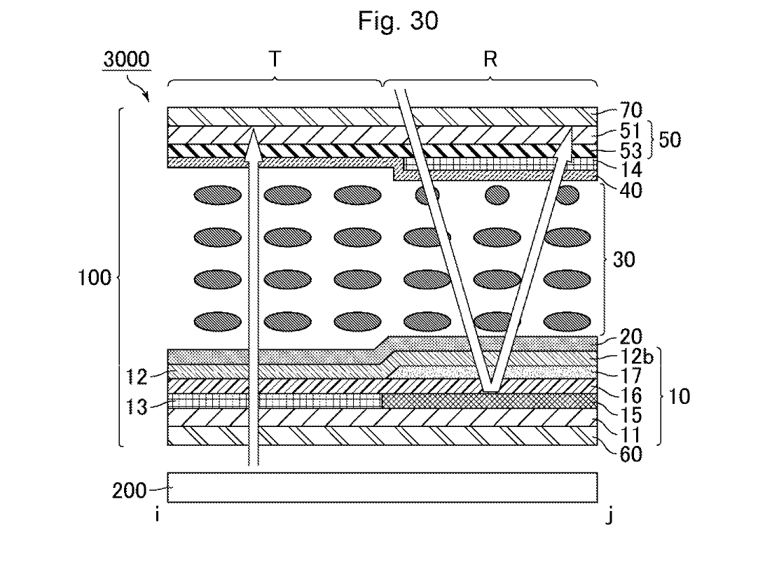

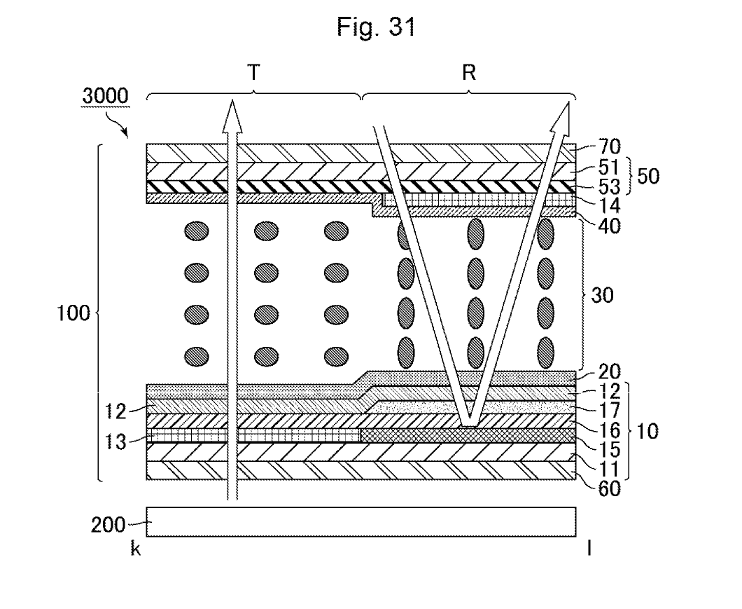

FIG. 30 is a schematic cross-sectional view of an exemplary liquid crystal display device of Embodiment 3 with no voltage applied. FIG. 31 is a schematic cross-sectional view of the liquid crystal display device shown in FIG. 30 with voltage applied. In FIG. 30 and FIG. 31, the white arrows indicate the paths of light.

As shown in FIG. 30 and FIG. 31, the second substrate 50 in a liquid crystal display device 3000 of Embodiment 3 includes the third electrode 14 in the reflective region R. In Embodiment 3, the second electrode 13 and the third electrode 14 are separate electrodes which are independent of each other. The third electrode 14 is disposed in the second substrate 50 to face the first electrode 12 across the liquid crystal layer 30 in the reflective region R. The third electrode 14 and the first electrode 12 disposed in the reflective region R are planar electrodes. The second electrode 13 and the third electrode 14 are common electrodes, and preferably receive the same signals. The second electrode 13 and the third electrode 14 may be connected to each other via a contact hole, for example, or may be connected by a conductive line introduced from the outside of the liquid crystal display panel after bonding of the first substrate 10 and the second substrate 50. In Embodiment 3, with voltage applied, the device provides display in a horizontal alignment mode in the transmissive region T and provides display in a vertical alignment mode in the reflective region R.

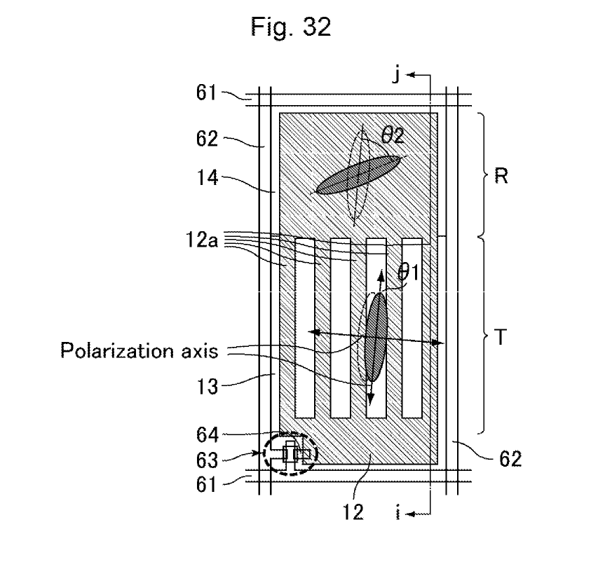

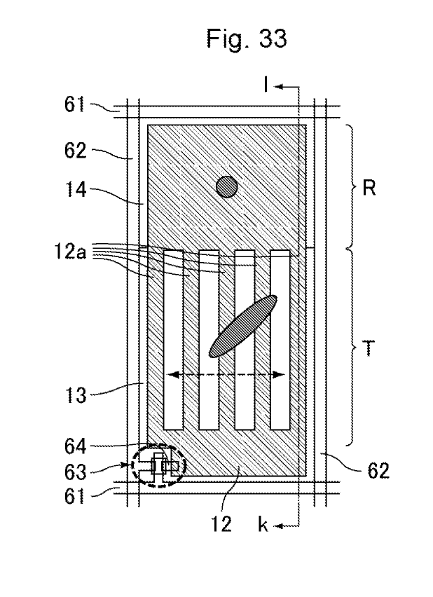

FIG. 32 and FIG. 33 are a schematic plan view of the liquid crystal display device shown in FIG. 30 with no voltage applied and a schematic plan view of the liquid crystal display device with voltage applied, respectively. In FIG. 32, liquid crystal molecules adjacent to the first alignment film 20 are indicated by dotted lines, and liquid crystal molecules adjacent to the second alignment film 40 are indicated by solid lines. In FIG. 33, the double-headed dotted arrows each indicate the direction of an electric field. As shown in FIG. 30 and FIG. 32, with no voltage applied, liquid crystal molecules adjacent to the first alignment film 20 and liquid crystal molecules adjacent to the second alignment film 40 in the transmissive region T are parallel to each other. As in Embodiment 1, liquid crystal molecules present in the thickness direction of the liquid crystal layer 30 in the transmissive region T are aligned parallel to the liquid crystal molecules adjacent to the first alignment film 20 and the liquid crystal molecules adjacent to the second alignment film 40. The liquid crystal molecules are aligned at an azimuth parallel or perpendicular to the polarization axis of the first polarizer 60 or the second polarizer 70, so that the device provides black display. In the reflective region R, liquid crystal molecules adjacent to the first alignment film 20 and liquid crystal molecules adjacent to the second alignment film 40 form an angle θ2, exhibiting twist alignment. As in Embodiment 1, liquid crystal molecules present in the thickness direction of the liquid crystal layer 30 in the reflective region R are aligned along the twist between the liquid crystal molecules adjacent to the first alignment film 20 and the liquid crystal molecules adjacent to the second alignment film 40. In the reflective region R, the device provides black display by converting incident light from the outside into circularly polarized light and reflecting the circularly polarized light.

As shown in FIG. 31 and FIG. 33, with voltage applied, liquid crystal molecules adjacent to the first alignment film 20, liquid crystal molecules adjacent to the second alignment film 40, and liquid crystal molecules present in the thickness direction of the liquid crystal layer 30 in the transmissive region T are rotated by a horizontal electric field generated between the first electrode 12 and the second electrode 13 as in Embodiment 1, so that the device provides white display. In the reflective region R, liquid crystal molecules adjacent to the first alignment film 20, liquid crystal molecules adjacent to the second alignment film 40, and liquid crystal molecules present in the thickness direction of the liquid crystal layer 30 are aligned perpendicular to the substrate surfaces by a vertical electric field generated between the first electrode 12 and the third electrode 14. In the reflective region R, the device provides white display by reflecting incident light (linearly polarized light) from the outside.

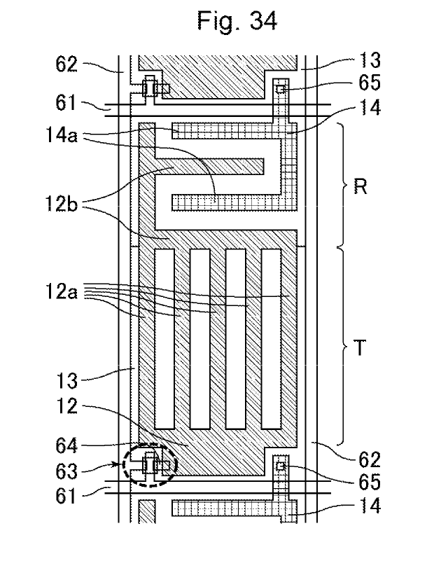

Although the drawings for Embodiments 1 and 2 show the cases where the transmissive region T and the reflective region R are in the FFS mode, the transmissive region T and/or the reflective region R may be in the IPS mode as described above. The case where the transmissive region T and/or the reflective region R are/is in the IPS mode is described below with reference to FIG. 34 to FIG. 36. FIG. 34 to FIG. 36 are schematic plan views of the liquid crystal display devices of Embodiments 1 and 2, with the reflective region in the IPS mode, with the transmissive region in the IPS mode, and with the reflective region and the transmissive region in the IPS mode, respectively.

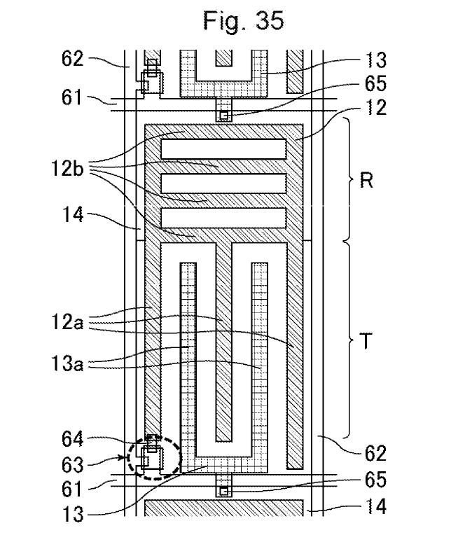

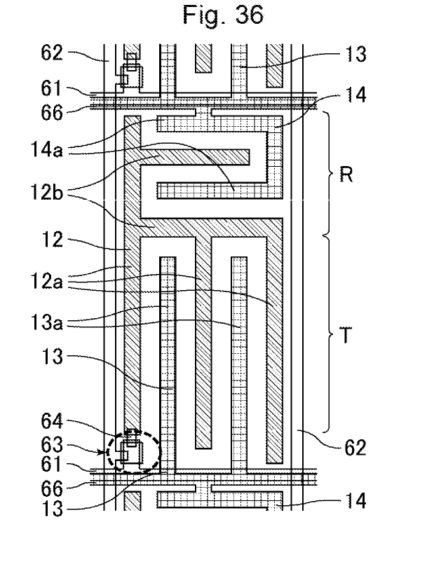

In the case where the reflective region R is in the IPS mode, as shown in FIG. 34, the first electrode 12 and the third electrode 14 are formed on the same insulating layer in the reflective region R, the third electrode 14 includes one or more third linear electrode portions 14a, and the second linear electrode portions 12b and the third linear electrode portions 14a are disposed to face each other. The third electrode 14 and the second electrode 13 may be connected to each other by any method as long as they can receive the same signals. The third electrode 14 receives the same signals as the second electrode 13 via the contact hole 65, for example. In the case where the second electrode 13 and the transmissive region T are in the IPS mode, as shown in FIG. 35, the first electrode 12 and the second electrode 13 are formed on the same insulating layer in the transmissive region T, the second electrode 13 includes one or more fourth linear electrode portions 13a, and the first linear electrode portions 12a and the fourth linear electrode portions 13a are disposed to face each other. The second electrode 13 receives the same signals as the third electrode 14 via the contact hole 65, for example. In the case where the reflective region R and the transmissive region T are in the IPS mode, as shown in FIG. 36, the second linear electrode portions 12b and the third linear electrode portions 14a are disposed to face each other in the reflective region R while the first linear electrode portions 12a and the fourth linear electrode portions 13a are disposed to each other in the transmissive region T. The second electrode 13 and the third electrode 14 are, for example, formed on the same insulating layer, and receive the same signals from a conductive line 66.

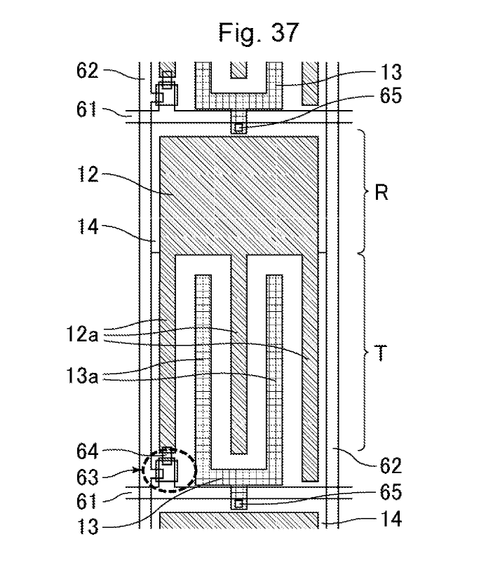

Although the drawings for Embodiment 3 show the case where the transmissive region T is in the FFS mode, the transmissive region T may be in the IPS made as described above. FIG. 37 is a schematic plan view of the liquid crystal display device of Embodiment 3 with the transmissive region in the IPS mode. As shown in FIG. 37, in the case where the transmissive region T is in the IPS mode, the first electrode 12 and the second electrode 13 are formed on the same insulating layer in the transmissive region T, the second electrode 13 includes one or more fourth linear electrode portions 13a, and the first linear electrode portions 12a and the fourth linear electrode portions 13a are disposed to face each other. The second electrode 13 receives the same signals as the third electrode 14 via the contact hole 65, for example. The second electrode 13 and the third electrode 14 may be connected to each other via the contact hole 65 in one pixel or in multiple pixels.

The liquid crystal display devices of Embodiments 1 to 3 each have a configuration including, as well as the liquid crystal display panel 100 and the backlight 200, multiple components including external circuits such as a tape-carrier package (TCP) and a printed circuit board (PCB); optical films such as a viewing angle-increasing film and a luminance-increasing film; and a bezel (frame). Some components, if appropriate, may be incorporated into another component. Components other than those described above are not particularly limited and are not described here because such components can be those commonly used in the field of liquid crystal display devices.

Hereinabove, embodiments of the present invention have been described. All the individual matters described herein are applicable to the entire scope of the present invention.

The present invention is described in more detail with reference to examples and comparative examples. The examples, however, are not intended to limit the scope of the present invention.

### Example 1

In Example 1, the liquid crystal display device 1000 was produced in which the reflective region R has Configuration 1. Example 1 employs the same configuration as the liquid crystal display device of Embodiment 1. In the liquid crystal display device 1000, the transmissive region T and the reflective region R had the FFS mode electrode arrangement. In Example 1, the first substrate 10 includes the first electrode 12 as a pixel electrode in the transmissive region T and the reflective region R. The second substrate 50 includes the black matrix 52 and the color filter layers 53. On the first substrate 10 and the second substrate 50 were formed the first alignment film 20 and the second alignment film 40, which are photo-alignment films, respectively.

The first electrode 12 includes one or more first linear electrode portions 12a in the transmissive region T and one or more second linear electrode portions 12b in the reflective region R. The first electrode 12 is a pixel electrode and is formed in each pixel. The first linear electrode portions 12a and the second linear electrode portions 12b were formed with extension directions thereof being perpendicular to each other. The first linear electrode portions 12a and the second linear electrode portions 12b each had a width of 2.7 μm. The distance between adjacent first linear electrode portions 12a and the distance between adjacent second linear electrode portions 12b were each 3.3 μm. The first substrate 10 also includes the second electrode 13 and the third electrode 14, and the second electrode 13 and the third electrode 14 constitute one electrode. The second electrode 13 and the third electrode 14 are common electrodes and receive the same signals. The first polarizer 60 and the second polarizer 70 were disposed with polarization axes thereof being in crossed Nicols.

The first alignment film 20 and the second alignment film 40 were subjected to alignment treatment such that with no voltage applied, liquid crystal molecules in the transmissive region T formed a twist angle θ1 of 0° and liquid crystal molecules in the reflective region R formed a twist angle θ2 of 63.50. Also, in the transmissive region T, the alignment azimuth of liquid crystal molecules adjacent to the first alignment film 20 and the alignment azimuth of liquid crystal molecules adjacent to the second alignment film 40 were parallel to the polarization axis of the second polarizer 70. Furthermore, the alignment azimuth of liquid crystal molecules adjacent to the second alignment film 40 in the reflective region R was parallel to the alignment azimuth of liquid crystal molecules adjacent to the second alignment film 40 in the transmissive region T.

In the alignment treatment, the first light irradiation was performed on the regions of the first alignment film 20 corresponding to the transmissive region T while the regions corresponding to the reflective region R were shielded from the light with a mask formed of a light-shielding material. Then, the second light irradiation was performed on the regions corresponding to the reflective region R while the regions corresponding to the transmissive region T were shielded from light with the above mask. The second light irradiation was performed from a different light irradiation direction such that the alignment azimuth of liquid crystal molecules adjacent to the first alignment film 20 in the reflective region R formed an angle of 63.5° with the alignment azimuth of liquid crystal molecules adjacent to the first alignment film 20 in the transmissive region T. The second alignment film 40 was irradiated with light from the same direction for both the transmissive region T and the reflective region R.

After the alignment treatment, a composition containing liquid crystal molecules was dropped onto one of the first substrate 10 and the second substrate 50 and the substrates were bonded to each other, whereby the liquid crystal layer 30 was formed. The liquid crystal molecules used had an anisotropy (Δε) of dielectric constant of 7 and a refractive index anisotropy (Δn) of 1.02. The liquid crystal retardation value (Δnd) in the transmissive region T was 340 nm, and the liquid crystal retardation value (Δnd) in the reflective region R was 195 nm. With an applied voltage of 0 V, the device provided black display in both the transmissive region T and the reflective region R. With an applied voltage of 4 V, the device provided white display in both the transmissive region T and the reflective region R. The alignment division treatment can also be performed using a wire grid polarizer.

### Example 2

A liquid crystal display device 2000A of Example 2 was produced by the same procedure as in Example 1, except that the reflective region R had Configuration 2, the liquid crystal layer 30 had the same thickness in the reflective region and the transmissive region, and the first alignment film 20 and the second alignment film 40 were subjected to the alignment treatment from different azimuths. Example 2 employed the same configuration as the exemplary liquid crystal display device of Embodiment 2. In Example 2, with no voltage applied, the alignment azimuth of liquid crystal molecules adjacent to the first alignment film 20 and the alignment azimuth of liquid crystal molecules adjacent to the second alignment film 40 in the transmissive region T were parallel to each other and were also parallel to the polarization axis of the second polarizer 70. The alignment treatment was performed such that the alignment azimuth of liquid crystal molecules adjacent to the first alignment film 20 in the reflective region R was parallel to the alignment azimuth of liquid crystal molecules adjacent to the first alignment film 20 in the transmissive region T, and the alignment azimuth of liquid crystal molecules adjacent to the second alignment film 40 in the reflective region R formed an angle of 36.5° with the alignment azimuth of liquid crystal molecules adjacent to the first alignment film 20 in the reflective region R.

In the alignment treatment, the first light irradiation was performed on the regions of the second alignment film 40 corresponding to the transmissive region T while the regions corresponding to the reflective region R were shielded from the light with a mask formed of a light-shielding material. Then, the second light irradiation was performed on the regions corresponding to the reflective region R while the regions corresponding to the transmissive region T were shielded from light with the above mask. The second light irradiation was performed from a different light irradiation direction such that the alignment azimuth of liquid crystal molecules adjacent to the second alignment film 40 in the reflective region R formed an angle of 36.5° with the alignment azimuth of liquid crystal molecules adjacent to the second alignment film 40 in the transmissive region T. The first alignment film 20 was irradiated with light from the same direction for both the transmissive region T and the reflective region R. Both the liquid crystal retardation values (Δnd) of the transmissive region T and the reflective region R were 390 nm. With voltage applied, the device provided black display both in the transmissive region T and the reflective region R. With voltage applied, the device provided white display both in the transmissive region T and the reflective region R. The alignment division treatment can also be performed using a wire grid polarizer.

### Example 3

A liquid crystal display device 2000B of Example 3 was produced by the same procedure as in Example 2, except that the liquid crystal layer 30 had a greater thickness in the reflective region R than in the transmissive region T. Example 3 employed the same configuration as the exemplary liquid crystal display device of Modified Example 1 of Embodiment 2. The liquid crystal retardation value (Δnd) of the transmissive region T was 340 nm and the liquid crystal retardation value (Δnd) of the reflective region R was 390 nm.

### Example 4

A liquid crystal display device 3000 of Example 4 was produced by the same procedure as in Example 1, except that the reflective region R is in a vertical alignment mode. Example 4 employed the same configuration as the exemplary liquid crystal display device of Embodiment 3. The liquid crystal display device 3000 had the FFS mode electrode arrangement in the transmissive region T and a vertical alignment mode electrode arrangement in the reflective region R. Example 4 employed a planar electrode in the reflective region R and the first electrode 12 including one or more first linear electrode portions 12a in the transmissive region T. The first substrate 10 includes the planar second electrode 13 in the reflective region R and the second electrode 13 and the third electrode 14 are separate electrodes. The second substrate 50 includes the planar third electrode 14 in the reflective region R. The first electrode 12 is a pixel electrode. The second electrode 13 and the third electrode 14 are common electrodes and receive the same signals. With no voltage applied, the device provided back display both in the transmissive region T and the reflective region R. With voltage applied, the device provided white display both in the transmissive region T and the reflective region R. Configuration 2 may be applied to Example 4, or Configuration 2 may be applied to Example 4 and the liquid crystal layer 30 may have the same thickness in the reflective region R and the transmissive region T.

The transmissive region T in Examples 1 to 4 and the reflective region R in Examples 1 to 3 had the FFS mode electrode arrangement, but may have the IPS mode electrode arrangement to achieve the same effect. The concept of the present invention is also applicable to liquid crystal molecules having negative anisotropy of dielectric constant.

### [Additional Remarks]

One aspect of the present invention may be a liquid crystal display device including a transmissive region and a reflective region, including a backlight unit and a liquid crystal display panel including a first substrate, a first alignment film, a liquid crystal layer containing liquid crystal molecules having positive anisotropy of dielectric constant, a second alignment film, and a second substrate in the given order from closest to farthest from the backlight unit, the first substrate including a first electrode disposed in the transmissive region and the reflective region and a second electrode disposed in the transmissive region, the first substrate or the second substrate including a third electrode disposed in the reflective region, the first electrode including one or more first linear electrode portions in the transmissive region, with no voltage applied to the liquid crystal layer, the liquid crystal molecules in the transmissive region forming a twist angle θ1 of 0° or greater and smaller than 30°, the liquid crystal molecules in the reflective region forming a twist angle θ2 of 30° or greater and 80° or smaller, and an alignment azimuth of liquid crystal molecules adjacent to the first alignment film in the reflective region or an alignment azimuth of liquid crystal molecules adjacent to the second alignment film in the reflective region being parallel to the alignment azimuth of liquid crystal molecules adjacent to the first alignment film in the transmissive region. With liquid crystal molecules twist-aligned between the upper and lower substrates in the reflective region with no voltage applied, white display and black display can be provided without any in-cell retarder while brightness inversion between the transmissive region and the reflective region can be avoided. Furthermore, the thickness of the liquid crystal layer in the reflective region can be half or more of the thickness of the liquid crystal layer in the transmissive region when the alignment azimuth of liquid crystal molecules near the upper substrate and the alignment azimuth of liquid crystal molecules near the lower substrate form an angle of 30° or greater and 80° or smaller. This configuration can enhance response performance of the liquid crystal molecules in the reflective region and reduce current leakage between the upper and lower substrates.

The liquid crystal display device may further include a first polarizer disposed on a surface of the first substrate remote from the liquid crystal layer and a second polarizer disposed on a surface of the second substrate remote from the liquid crystal layer, wherein the first polarizer and the second polarizer may be disposed with polarization axes thereof being perpendicular to each other, and with no voltage applied to the liquid crystal layer, the alignment azimuth of liquid crystal molecules adjacent to the first alignment film in the transmissive region and the alignment azimuth of liquid crystal molecules adjacent to the second alignment film in the transmissive region may be parallel to the polarization axis of the first polarizer or the second polarizer.

The first substrate may include a reflector in the reflective region. The reflector emits incident light from the outside through the liquid crystal layer to the outside again through the liquid crystal layer, so that white display is achieved.

With no voltage applied to the liquid crystal layer, the twist angle θ2 may be 59° or greater and 68° or smaller, the alignment azimuth of liquid crystal molecules adjacent to the second alignment film in the reflective region may be parallel to the alignment azimuth of liquid crystal molecules adjacent to the second alignment film in the transmissive region, and the reflective region may have a liquid crystal retardation value (Δnd) represented by the following formula (1) of 170 nm or greater and 220 nm or smaller,

Liquid crystal retardation value (Δnd)=refractive index anisotropy (Δn) of liquid crystal molecules×thickness (d) of liquid crystal layer Formula (1).

With no voltage applied to the liquid crystal layer, the twist angle θ2 may be 32° or greater and 41° or smaller, the alignment azimuth of liquid crystal molecules adjacent to the first alignment film in the reflective region may be parallel to the alignment azimuth of liquid crystal molecules adjacent to the first alignment film in the transmissive region, and the reflective region may have a liquid crystal retardation value (Δnd) represented by the following formula (1) of 375 nm or greater and 405 nm or smaller,

Liquid crystal retardation value (Δnd)=refractive index anisotropy (Δn) of liquid crystal molecules×thickness (d) of liquid crystal layer Formula (1).

The liquid crystal layer may have the same thickness in the reflective region and the transmissive region.

The liquid crystal layer may have different thicknesses in the reflective region and the transmissive region.

The third electrode may be disposed in the first substrate, the first electrode may include one or more second linear electrode portions in the reflective region, and the one or more first linear electrode portions and the one or more second linear electrode portions may be disposed with extension directions thereof being perpendicular to each other. In this case, the direction of the electric field generated in the reflective region can be perpendicular to the direction of the electric field generated in the transmissive region such that upon application of voltage, the liquid crystal molecules in the reflective region are aligned at an azimuth parallel or perpendicular to the polarization axis of the first polarizer or the second polarizer.

The first electrode and the third electrode may be stacked with an insulating layer in between in the reflective region, and the third electrode may be a planar electrode. In other words, the reflective region may have the FFS mode electrode arrangement. Also, the first electrode and the third electrode may be formed on the same insulating layer in the reflective region, the third electrode may include one or more third linear electrode portions, and the one or more second linear electrode portions and the one or more third linear electrode portions may be disposed to face each other. In other words, the reflective region may have the IPS mode electrode arrangement. With the reflective region being in a horizontal alignment mode such as the FFS mode or the IPS mode, the reflective region can exhibit favorable viewing angle characteristics.

The third electrode may be disposed on the second substrate to face the first electrode across the liquid crystal layer, and the third electrode and the first electrode disposed in the reflective region may be planar electrodes. In other words, the liquid crystal display device may provide display in a vertical alignment mode in the reflective region.

The first linear electrode portion may have a width of 1.5 μm or smaller or 3.8 μm or greater.

The liquid crystal display device may have an L/S ratio between the width (L) of the one or more first linear electrode portions and the distance (S) between adjacent first linear electrode portions of 0.1 to 0.4 or 1.7 to 4.

The first electrode and the second electrode may be stacked with an insulating layer in between in the transmissive region, and the second electrode may be a planar electrode. In other words, the transmissive region may have the FFS mode electrode arrangement. Also, the first electrode and the second electrode may be formed on the same insulating layer in the transmissive region, the second electrode may include one or more fourth linear electrode portions, and the one or more first linear electrode portions and the one or more fourth linear electrode portions may be disposed to face each other. In other words, the transmissive region may have the IPS mode electrode arrangement. With the transmissive region being in a horizontal alignment mode such as the FFS mode or the IPS mode, the transmissive region can exhibit favorable viewing angle characteristics.

The modes of the present invention described above may appropriately be combined within the spirit of the present invention.

### REFERENCE SIGNS LIST

10: First substrate
11: Transparent substrate
12: First electrode
12a: First linear electrode portion
12b: Second linear electrode portion
13: Second electrode
13a: Fourth linear electrode portion
14: Third electrode
14a: Third linear electrode portion
15: Reflector
16, 17: Insulating layer
20: First alignment film
30: Liquid crystal layer
40: Second alignment film
50: Second substrate (color filter substrate)
51: Transparent substrate
52: Light-shielding layer (black matrix) between pixels
53: Color filter layer
53B: Blue color filter layer
53G: Green color filter layer
53R: Red color filter layer
54: Overcoat layer
55: Multi-gap layer
56: Photo spacer layer
60: First polarizer
61: Gate signal line
62: Source signal line
63: TFT
64: Drain line
65: Contact hole
66: Conductive line
70: Second polarizer
100: Liquid crystal display panel
200: Backlight unit
1000, 2000A, 2000B, 3000: Liquid crystal display device
T: Transmissive region
R: Reflective region

1. A liquid crystal display device including a transmissive region and a reflective region, comprising
a backlight unit and
a liquid crystal display panel including a first substrate, a first alignment film, a liquid crystal layer containing liquid crystal molecules having positive anisotropy of dielectric constant, a second alignment film, and a second substrate in the given order from closest to farthest from the backlight unit,
the first substrate including a first electrode disposed in the transmissive region and the reflective region and a second electrode disposed in the transmissive region,
the first substrate or the second substrate including a third electrode disposed in the reflective region,
the first electrode including one or more first linear electrode portions in the transmissive region,
with no voltage applied to the liquid crystal layer, the liquid crystal molecules in the transmissive region forming a twist angle θ1 of 0° or greater and smaller than 30°, the liquid crystal molecules in the reflective region forming a twist angle θ2 of 30° or greater and 80° or smaller, and an alignment azimuth of liquid crystal molecules adjacent to the first alignment film in the reflective region or an alignment azimuth of liquid crystal molecules adjacent to the second alignment film in the reflective region being parallel to the alignment azimuth of liquid crystal molecules adjacent to the first alignment film in the transmissive region.

2. The liquid crystal display device according to claim 1, further comprising a first polarizer disposed on a surface of the first substrate remote from the liquid crystal layer and a second polarizer disposed on a surface of the second substrate remote from the liquid crystal layer,
wherein the first polarizer and the second polarizer are disposed with polarization axes thereof being perpendicular to each other, and
with no voltage applied to the liquid crystal layer, the alignment azimuth of liquid crystal molecules adjacent to the first alignment film in the transmissive region and the alignment azimuth of liquid crystal molecules adjacent to the second alignment film in the transmissive region are parallel to the polarization axis of the first polarizer or the second polarizer.

3. The liquid crystal display device according to claim 1,
wherein the first substrate includes a reflector in the reflective region.

4. The liquid crystal display device according to claim 1,
wherein with no voltage applied to the liquid crystal layer,
the twist angle θ2 is 59° or greater and 68° or smaller,
the alignment azimuth of liquid crystal molecules adjacent to the second alignment film in the reflective region is parallel to the alignment azimuth of liquid crystal molecules adjacent to the second alignment film in the transmissive region, and
the reflective region has a liquid crystal retardation value (Δnd) represented by the following formula (1) of 170 nm or greater and 220 nm or smaller,
Liquid crystal retardation value (Δnd)=refractive index anisotropy (Δn) of liquid crystal molecules×thickness (d) of liquid crystal layer Formula (1).

5. The liquid crystal display device according to claim 1,
wherein with no voltage applied to the liquid crystal layer,
the twist angle θ2 is 320 or greater and 41 or smaller,
the alignment azimuth of liquid crystal molecules adjacent to the first alignment film in the reflective region is parallel to the alignment azimuth of liquid crystal molecules adjacent to the first alignment film in the transmissive region, and
the reflective region has a liquid crystal retardation value (Δnd) represented by the following formula (1) of 375 nm or greater and 405 nm or smaller,
Liquid crystal retardation value (Δnd)=refractive index anisotropy (Δn) of liquid crystal molecules×thickness (d) of liquid crystal layer Formula (1).

6. The liquid crystal display device according to claim 5,
wherein the liquid crystal layer has the same thickness in the reflective region and the transmissive region.

7. The liquid crystal display device according to claim 4,
wherein the liquid crystal layer has different thicknesses in the reflective region and the transmissive region.

8. The liquid crystal display device according to claim 1,
wherein the third electrode is disposed in the first substrate,
the first electrode includes one or more second linear electrode portions in the reflective region, and
the one or more first linear electrode portions and the one or more second linear electrode portions are disposed with extension directions thereof being perpendicular to each other.

9. The liquid crystal display device according to claim 8,
wherein the first electrode and the third electrode are stacked with an insulating layer in between in the reflective region, and
the third electrode is a planar electrode.

10. The liquid crystal display device according to claim 8,
wherein the first electrode and the third electrode are formed on the same insulating layer in the reflective region,
the third electrode includes one or more third linear electrode portions, and
the one or more second linear electrode portions and the one or more third linear electrode portions are disposed to face each other.

11. The liquid crystal display device according to claim 1,
wherein the third electrode is disposed on the second substrate to face the first electrode across the liquid crystal layer, and
the third electrode and the first electrode disposed in the reflective region are planar electrodes.

12. The liquid crystal display device according to claim 1,
wherein the first linear electrode portion has a width of 1.5 μm or smaller or 3.8 μm or greater.

13. The liquid crystal display device according to claim 1,
which has an US ratio between the width (L) of the one or more first linear electrode portions and the distance (S) between adjacent first linear electrode portions of 0.1 to 0.4 or 1.7 to 4.

14. The liquid crystal display device according to claim 1,
wherein the first electrode and the second electrode are stacked with an insulating layer in between in the transmissive region, and
the second electrode is a planar electrode.

15. The liquid crystal display device according to claim 1,
wherein the first electrode and the second electrode are formed on the same insulating layer in the transmissive region,
the second electrode includes one or more fourth linear electrode portions, and
the one or more first linear electrode portions and the one or more fourth linear electrode portions are disposed to face each other.
